(19) United States
(12) Patent Application Publication
(10) Pub. No.: US 2003/0151621 A1
(43) Pub. Date: Aug. 14, 2003

(54) User interface system

(76) Inventors: Chris McEvilly, Bagshot (GB); Tudor Vers, Langstone (GB); Matthew Chamberlain, Wargrave (GB); Martyn Steele, Old Windsor (GB); Manish Upendran, San Jose, CA (US); Richard Bettelheim, Pacifica, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/260,256

(22) Filed: Sep. 27, 2002

Related U.S. Application Data
(63) Continuation-in-part of application No. PCT/GB02/01610, filed on Apr. 3, 2002.

(30) Foreign Application Priority Data
Apr. 3, 2001 (GB) GB0108354.2

(51) Int. Cl. G09G 5/00

(52) U.S. Cl. 345/744

(57) ABSTRACT

A system and method for providing a user with access to a plurality of television services and content from a number of remote servers and that provides the user with access to the desired service and content through a graphical interface that is customisable and personalised for each user. In one embodiment, the system includes application components, a database component, one or more user interface servers and one or more user devices. The application components provide the user with their services such as, for example, electronic programme guide service, video on demand service, world wide web access, electronic mail etc. These systems retrieve and provide the content that is accessed and ultimately delivered to the user for viewing and interactivity. The database component contains user profile data and usage information as well as content and formatting data. The user interface server accesses data from the database component and from the application components and processes the data to generate the personalised user interface, personalised electronic programme guide and application content for delivery to the user device through the data network.

The present application is a continuation-in-part application of PCT application no. PCT/GB02/01610, filed Apr. 3, 2002, which in turn claims priority from UK provisional application no. GB0108354.2, filed Apr. 3, 2001. The present application claims the benefit of the filing date of both of these applications.

The present invention relates to a user interface system which, in one embodiment, provides a user with access to a plurality of services and content such as e-mail, broadcast television, video on demand, web access etc.

### BACKGROUND OF THE INVENTION

Conventionally, television programmes have been broadcast to users via RF signals transmitted from terrestrial base stations, via signals transmitted from overhead satellites and via signals transmitted over cable to user premises. Each of these systems offers the user the ability to watch a number of different channels which can be selected by the user. These existing systems, however, require all of the channels to be transmitted to the user's television receiver, which then tunes into and displays one of the channels in accordance with the user's selection. In some of these conventional systems, the user must subscribe to the service provider in order to be able to view some of the channels. However, since each user's television receiver receives all of the channels, users can still gain access to restricted channels using appropriate hacking equipment which can bypass the service provider's security.

Further, with these conventional systems, the television viewing experience for the user is one in which the user is effectively passive. In other words, the programme schedule is fixed in advance by the service providers and the only choice that the user has is which channel he wishes to view. New interactive television systems are beginning to emerge in which the user can interact through the television with the service providers to control the content that is delivered, thereby creating a more personal entertainment experience. These systems employ menu-based user interface systems to allow the user access to the various services that are available. However, to date, these menu-based interfaces are difficult and confusing for the user to operate. Further, current menu interface systems are designed as “one size fits all” systems, typically transmitting to and displaying for every user of the system in a particular region the same channel line-up (usually in numerical order) and programming information in the same format and style.

In order to provide users having conventional television sets with the ability to be able to interact with the service providers, a user set top box (STB) is provided. At present, various service providers have produced their own set top box, each having different hardware and software loaded thereon. The service providers have focussed on adding significant processing power and storage capacity to the set top box and download proprietary software for maintaining, processing and displaying the bulk of the control data such as, for example, user profile data, programme guide data and usage data. As a result of the complexity of these proprietary set top boxes, the overhead associated with deploying, maintaining, upgrading, monitoring and using the system requires significant user support. In particular, each time a change is made to such systems, each user's set top box needs to be checked and upgraded or even replaced. Further, with this type of system the development of new applications is more difficult and time consuming, since each application must be written in a format that suits the processor speed, operating system and internal architecture of each set top box.

### BRIEF DESCRIPTION OF THE DRAWINGS

The present invention is illustrated by way of example and not limitation in the figures of the accompanying drawings, in which like references indicate similar elements and in which:

FIG. 1 is a schematic block diagram of the architecture of an exemplary system for providing a user with access to a plurality of services and content;

FIG. 2a is a schematic block diagram illustrating the main components of a user set top box forming part of the system shown in FIG. 1 and FIG. 2b illustrates the format of an exemplary user request;

FIG. 3 is a schematic block diagram illustrating the main components of an exemplary user interface server forming part of the system shown in FIG. 1;

FIG. 4 is a schematic block diagram illustrating the main components of an exemplary request handler which forms part of the user interface server shown in FIG. 3;

FIG. 5 is a schematic block diagram illustrating the main components of an exemplary response handling unit which forms part of the user interface server shown in FIG. 3;

FIG. 6 is a block diagram illustrating the main components of an exemplary application server forming part of the system shown in FIG. 1;

FIG. 7 is a block diagram illustrating the main components of an exemplary database forming part of the system shown in FIG. 1;

FIG. 8 is a functional flowchart illustrating an exemplary way in which the user can access the user interface menu system which provides the user with access to the services and content provided by the remote servers shown in FIG. 1;

FIG. 9 is a schematic diagram illustrating the main components of the exemplary remote control shown in FIG. 1;

FIG. 10 schematically illustrates the form and layout of an exemplary main menu page showing a Yourspace option, a Videospace option, a TVspace option and an Openspace option;

FIG. 11 is a flowchart illustrating an exemplary menu logic associated with the TVspace option shown in FIG. 10;

FIG. 12 illustrates an exemplary main menu page associated with the TVspace option shown in FIG. 10;

FIG. 13 illustrates an exemplary menu page shown in FIG. 12 and illustrating the operation of a menu carousel within the menu page;

FIG. 14 illustrates an initial page of an exemplary electronic programme guide selected from the TVspace menu shown in FIG. 13;

FIG. 15 illustrates an exemplary menu page for a channel selected from the menu page shown in FIG. 14;

FIG. 16 illustrates an exemplary pay-per-view menu page accessed from the TVspace main menu shown in FIG. 12;

FIG. 17 illustrates the pay-per-view menu page shown in FIG. 16 with a confirmation message when a user is about to buy a pay-per-view menu item;

FIG. 18 is a flowchart illustrating an exemplary validate user routine carried out during a purchasing operation;

FIG. 19 illustrates an exemplary pay-per-view menu page showing a prompt for the user to enter a user PIN number during the process of buying a pay-per-view menu item;

FIG. 20 is a flowchart illustrating an exemplary operation of a search option which can be accessed from the TVspace menu page shown in FIG. 12;

FIG. 21 illustrates a search menu page illustrating different exemplary search options that can be chosen for carrying out a search;

FIG. 22 illustrates an exemplary search page together with a prompt and a text box for the user to enter a text string to search;

FIG. 23 is a flowchart illustrating an exemplary change-user procedure which can be accessed from various menu pages;

FIG. 24 illustrates an exemplary TVspace main menu shown in FIG. 12 after a change-user option has been selected;

FIG. 25 is a flowchart illustrating an exemplary favourites procedure which can be accessed from various menu pages;

FIG. 26 is a flowchart illustrating exemplary menu logic associated with the Videospace option shown in FIG. 10;

FIG. 27 illustrates an exemplary main menu page associated with the Videospace option shown in FIG. 10;

FIG. 28 illustrates an exemplary Top Ten menu page of the Videospace option;

FIG. 29 illustrates an exemplary menu page providing different options for a selected video within the Videospace option;

FIG. 30 is a flowchart illustrating an exemplary Videoshelf option available within Videospace;

FIG. 31 is a flowchart illustrating exemplary menu logic associated with the Yourspace option shown in FIG. 10;

FIG. 32 illustrates an exemplary main menu page associated with the Yourspace option shown in FIG. 10;

FIG. 33a is a flowchart illustrating a first part of exemplary menu logic associated with a Your Account option available from the Yourspace menu shown in FIG. 32;

FIG. 33b is a flowchart illustrating a second part of the exemplary menu logic associated with a Your Account option available from the Yourspace menu shown in FIG. 32;

FIG. 33c is a flowchart illustrating a final part of the exemplary menu logic associated with a Your Account option available from the Yourspace menu shown in FIG. 32;

FIG. 34 illustrates an exemplary main menu page associated with the open space option shown in FIG. 10;

FIG. 35 illustrates an exemplary short electronic programme guide which can be accessed by users;

FIG. 36 is a schematic block diagram of an alternate exemplary embodiment of the architecture of a system for providing a user with access to a plurality of services and content;

FIG. 37 is a schematic block diagram illustrating the exemplary main components of a user set top box forming part of the system shown in FIG. 36;

### DETAILED DESCRIPTION

A user interface method and system are described herein. In the following description, for purposes of explanation, numerous specific details are set forth in order to provide a thorough understanding of the present invention. It will be evident, however, to one skilled in the art that the present invention may be practiced without these specific details.

According to one aspect, an embodiment of the present invention provides a system and method for providing a user with access to a plurality of services and content from a number of remote servers and that provides the user with access to the desired service and content through a graphical interface that is customisable and personalised for each user. In one embodiment, the system monitors the services that are requested by each user to update and maintain user profiling information for each user. This user profiling information can then be used, for example, to target services or content for the user.

In another embodiment, the menu pages are generated in a user interface server which is located between the users and the servers providing the desired service and/or content. By generating the menu pages in such an intermediate user interface server and then downloading the menu pages to the user, the design of the user device may be simplified. Further, since a common user interface server can act as an intermediary to a number of different application servers, a menu system having a consistent look and feel over the different application servers can be generated. As a result, the final user interface that is used by the end user can be simplified.

According to another aspect, an embodiment of the present invention provides a system for allowing users to gain access to the services and content provided by a number of remote servers using a cursorless graphical user interface. The interface may include a menu carousel having a selection window and in which the user can scroll, using keys of an input device, menu options through the selection window. The user interface may be embodied as a hierarchical menu system, making it easier for the user to navigate. In one embodiment, the user navigates through the menu levels and makes selections by using a control device that includes up, down, left, right and action functions. For example, the up and down functions may be used by the user to scroll up and down through the plurality of choices available on a menu carousel, and the left and right functions allow the user to move back and forth between different layers of the hierarchical menu structure. In this way, the user can navigate between menu levels, screens and carousels in a cursorless manner.

According to another aspect, the present invention provides a system for allowing a user to gain access to the services and/or content provided by a number of remote servers using a graphical user interface that is personalised for each user. In this embodiment, the menu design, selections, and content displayed to a user are based on user profile data and usage information maintained by the system in one or more databases. The stored user profile data and usage information may be used by the system to create a personalised menu including design elements, services and content based on the profile data and usage information of the user to which the menu will be presented. In this embodiment, each menu screen presented to a specific user may have a consistent design, look and feel and includes services and content targeted to that specific user.

According to another aspect, the present invention provides the user with a programme guide that is personalised for each user. The stored user profile data and usage information is used in the system together with an electronic programme guide to provide each user of the system with access to electronic programme guide data through the generated personalised programme guide. According to this aspect, in response to a user's request, the system retrieves the applicable electronic programme guide data from an electronic program guide server for processing, and then processes the electronic programme guide data based on the user's profile data and usage information stored in the system. Based on this stored information, the system can build a programme guide to be displayed to a specific user that is personalised for that specific user, displaying, for example, a channel line-up based on the user's indicated preferences and/or usage, the user's favourites list, and related programming information customised for the specific user. Further, design elements of the personalised programme guide such as, for example, the background colour, fonts and layout may be customised for the specific user based on the user profile data and usage information of the user to which the menu will be presented.

In one embodiment of the present invention, the system provides a user with access to a plurality of services and content and comprises application components, a database component, one or more user interface servers and one or more clients. The application components provide the user with their services such as, for example, electronic programme guide service, video on demand service, world wide web access, electronic mail etc. These systems retrieve and provide the content that is accessed and ultimately delivered to the user for viewing and interactivity. The database component contains user profile data and usage information as well as content and formatting data. The user interface server is designed to enable the integration of the application components, database component and user interface for delivery to the client through a network. The user interface server accesses data from the database component and from the application components and processes the data to generate the personalised user interface, personalised electronic programme guide and application content for delivery to the client through the network. Each client includes a client application running in a client device, such as a set top box or a personal computer. The client application is adapted to receive the personalised user interface data, personalised electronic programme guide data and application content and to display the appropriate menu screens and application content to the user.

Each of the system components, clients and servers may communicate using standards-based protocols and languages, as this facilitates their implementation. In one embodiment, the system is arranged to enable essentially all significant processing and data storage to be performed on the server side of the system, requiring the client device to be responsible for displaying menu pages and requested content to the user and sending user input and requests back to the server. In one embodiment, the user interface servers include caches for caching generalised menu pages delivered in response to previous user requests and, upon receipt of a new user request, are operable to check their caches to determine if the new user request can be responded to from the data within the caches. In this way, the user interface servers operate to try to reduce the number of requests passed on to application servers or on to the database. The caching of generalised menu pages in this way may be utilized to reduce the processing burden on the application servers and the database, thereby facilitating the scaling of the system to accommodate more users.

Overview

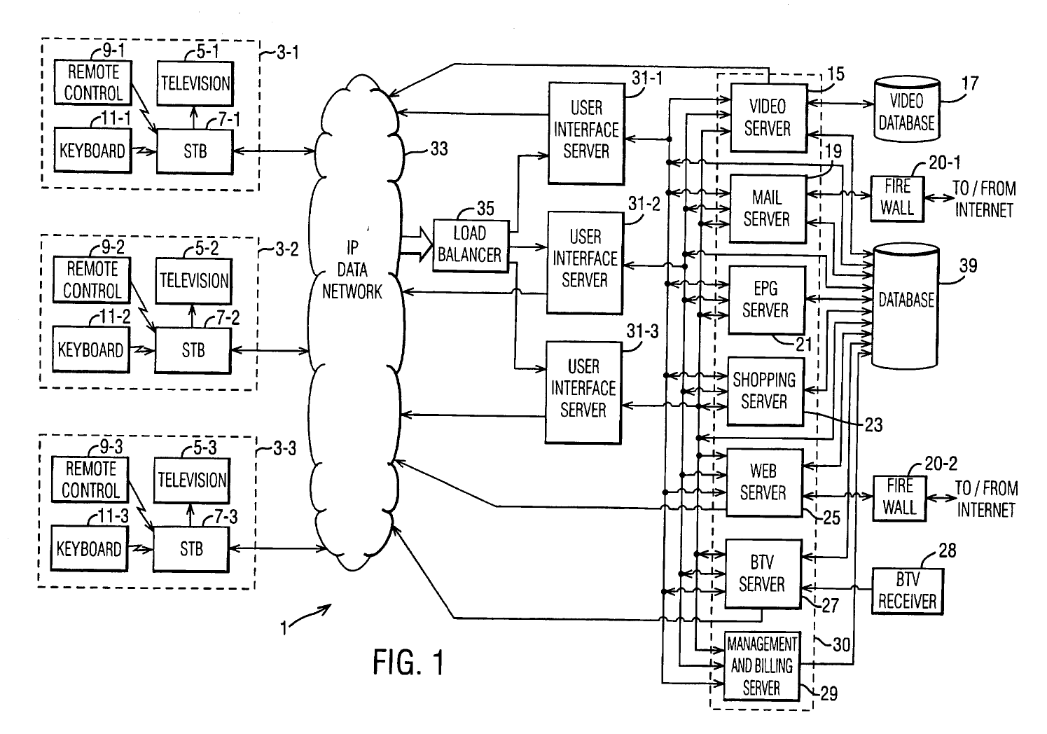

FIG. 1 is a schematic block diagram illustrating the main components of an exemplary system 1 which allows users to gain access to a plurality of services and content from a plurality of remote servers. The different users of the system 1 access the services and content via a respective user device 3, three of which are shown in FIG. 1 and referenced 3-1, 3-2 and 3-3. As shown in FIG. 1, in this embodiment, each user device 3 includes a television 5, a set top box (STB) 7, a remote control device 9 and a keyboard 11. In an alternative embodiments, the user device 3 may include any device (or combination of devices) with which a user may interact. Further examples of such user devices are described below. Menus for accessing the various services and content that are available are displayed to the user on the television 5 and the user selects and controls the accessing of the services and content using the remote control 9 and/or the keyboard 11.

In this embodiment, the services that the user can access include:

i) video on demand (e.g. films on demand, music on demand, time shifted TV, personal video recorder, video commerce etc.) from a video server 15 and a video database 17;

ii) e-mail from a mail server 19 which is connected to the Internet via a firewall 20-1;

iii) an electronic programme guide (EPG) from an EPG server 21;

iv) electronic commerce from a shopping server 23;

v) Internet/world wide web access via a web server 25 and a fire wall 20-2;

vi) broadcast TV (BTV) including basic television channels, premium channels, pay-per-view etc. provided by a BTV server 27 and a BTV receiver 28; and

vii) user services such as billing information, user profiles etc. provided by a management and billing server 29.

For ease of reference, the above servers will hereinafter be collectively referred to as application servers 30.

As shown in FIG. 1, in this embodiment, the accessing of the services or content provided by the application servers 30 is carried out via a number of user interface servers 31, three of which are shown in FIG. 1 and referenced 31-1, 31-2 and 31-3. The user interface servers 31 are operable to receive user requests transmitted from the associated set top box 7 via an IP data network 33 and a load balancer 35 (which shares the user requests between the user interface servers 31, based on how busy each is). In this embodiment, the user gains access to the different services and content provided by the application servers 30 via menu pages of a graphical user interface (which will be described in detail later). In this embodiment, these menu pages are generated by the user interface server 31 and downloaded over the IP data network 33 as HTML (hypertext markup language) files to the set top box 7. A web browser (not shown) in the set top box 7 then generates or renders the appropriate menu page from the received HTML file, which it displays to the user on the television 5.

When a user makes a selection from a menu page (using the remote control 9 or the keyboard 11) an appropriate user request is generated by the user set top box 7 and transmitted back to the user interface server 31. In response, the user interface server 31 tries to generate the next menu page itself from data stored in local caches (not shown). If the data is not available locally, then the user interface server 31 passes the user request on to the appropriate application server 30, which obtains the appropriate data and passes it back to the user interface server 31. The user interface server 31 then uses the received data to generate a personalised HTML file which it transmits back to the user set top box 7.

The data necessary for generating the various menu pages and the various user profile data are stored centrally within a database 39 which can be accessed by any of the application servers 30 or the user interface servers 31.

In this embodiment, the services or content of each application server 30 are accessed by the users from menu pages generated by the user interface servers 31. However, the resulting services or content may be delivered directly from the application servers 30 to the user or they may be delivered through the user interface server 31. In this embodiment, the application servers 30 which transmit large amounts of data to the users transmit their data directly to the users via the IP data network 33. These application servers 30 include the video server 15, the web server 25 and the broadcast TV server 27. The other servers (e.g., the mail server 19, the EPG server 21 and the shopping server 23) return their services through the user interface servers 31.

As those skilled in the art will appreciate, since the user interface servers 31 generate the menu pages used to gain access to the different services and content provided by the different application servers 30, the user interface servers 31 can ensure a common “look and feel” to the menu pages regardless of the application server 30 being accessed. As a result, the user interface menu system of this embodiment is easier to understand, use and learn than those of the prior art systems available today. Further, as will be described in more detail below, the user interface servers 31 use intelligent caching techniques and user profile information to personalise in an efficient way the menu pages downloaded to each user.

A brief description has been given above of the way in which users access services and content provided by a number of different application servers 30. A more detailed description will now be given of the various components used in the exemplary system 1 shown in FIG. 1 followed by a detailed description of the user interface menu system.

Set Top Box

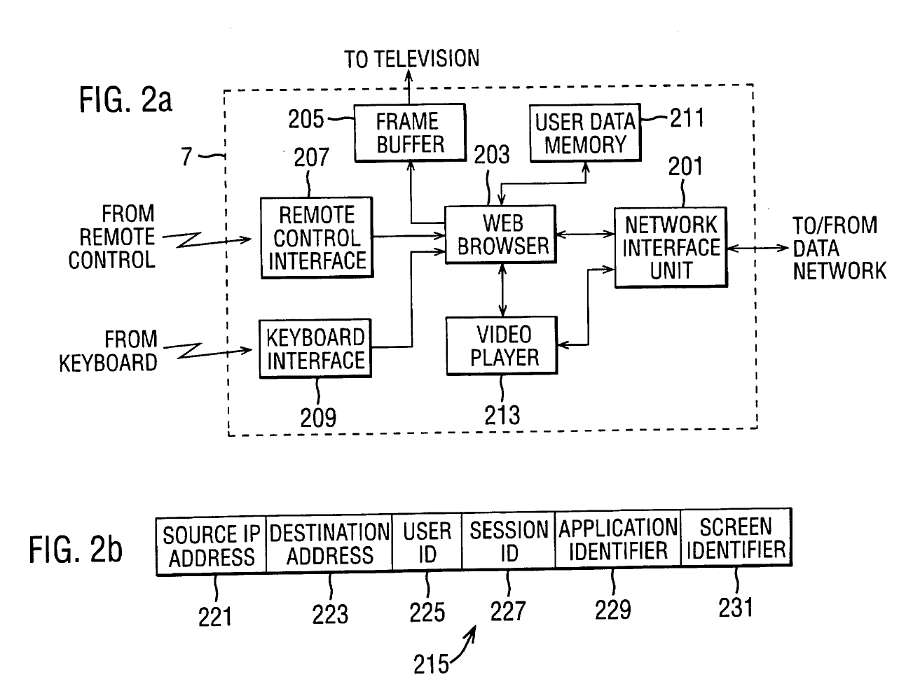

FIG. 2a is a functional block diagram illustrating exemplary main components of one of the set top boxes 7 shown in FIG. 1. As shown in FIG. 2a, the set top box 7 includes a network interface unit 201 which operates to interface the set top box 7 to the IP data network 33. HTML files received from a user interface server 31 over the IP data network 33 are passed, through the network interface unit 201, to a web browser 203 which processes the HTML file to generate a menu page which it outputs to a frame buffer 205 for display on the television 5. The web browser 203 is also operable to receive user input either from the remote control 9 via the remote control interface 207 or from the keyboard 11 via the keyboard interface 209. As will be described in more detail below, the user input is used to scroll through options on the currently displayed menu page and/or to select options from this menu page. The HTML file received from the user interface server 31 also includes links for other menu pages and/or services and content that are available from the current menu page. The HTML file received from the user interface server 31 also includes instructions for the web browser which associates key presses on the remote control 9 and/or the keyboard 11 to these links. When the user presses a key on the remote control 9 and/or the keyboard 11, the web browser 203 then interprets this key press based on the received instructions to identify the link that the user has selected. In this embodiment, these instructions are Javascript instructions and the web browser 203 includes an appropriate Javascript command processor (not shown) for interpreting the instructions. The web browser 203 then generates an appropriate user request for transmission to a user interface server 31, which user request includes the link corresponding to the key press together with user data (such as user ID, session ID etc.) stored in the user data memory 211.

FIG. 2b schematically illustrates the information in an exemplary user request 215 transmitted from the set top box 7 to the user interface server 31. As shown, the user request 215 includes:

i) a source IP address 221 identifying the IP address of the set top box 7 that transmitted the request;

ii) a destination address 223 (in this embodiment, the URL address of the user interface server 31) identifying that the request is to be transmitted through the IP data network 33 to a user interface server 31;

iii) a current user ID 225 which identifies the current user that is watching and interacting with the user device 3;

iv) a session ID 227 identifying a current user session to which the transmitted user request 215 relates; and

v) an application identifier 229 and a screen identifier 231 which together form the above-mentioned link associated with the current menu page being displayed, which identifies to the user interface server 31 the application server 30 to which the request should be transmitted and the particular menu page or service or content requested by the user.

The set top box 7 also includes a video player 213 (such as an MPEG decoder) which operates, under control of the web browser 203, to request a particular video stream from the video server 15 or a particular television channel from the broadcast television server 27. As shown in FIG. 2a, in this embodiment, the user request 215 is passed to the network interface unit 201 which then forwards the user request 215 over the IP data network 33 to a user interface server 31 which then forwards the user request 215 to the video server 15 or the BTV server 27. As mentioned above, in this embodiment, the video server 15 and the BTV server 27 are arranged to stream the requested video or television channel directly to the user over the IP data network 33. The stream of video or television channel data received from the IP data network 33 is then passed through the network interface unit 201 to the video player 213. The video player 213 then processes the received video or television channel data (which will typically be encoded using, for example, MPEG) to regenerate the frames of the video or television channel, which it passes back to the web browser 203. The web browser 203 then outputs the received video or television channel frames to the frame buffer 205 for display on the television 5. As will be illustrated below, in this embodiment, the web browser 203 can control the size of the video or television channel frames displayed to the user on the television 5 so that, for example, the video or television channel is displayed to the user in a portion of the television screen, with the remainder of the screen being used to display menu options that are available.

User Interface Server

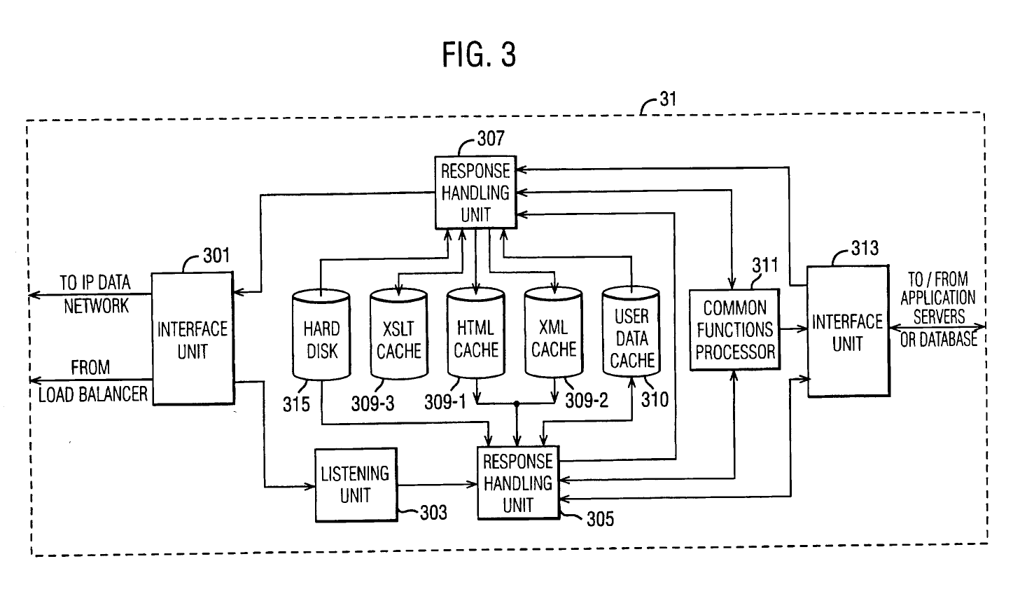

FIG. 3 is a functional block diagram illustrating the main components of an exemplary user interface server 31. As discussed above, the user interface server 31 is arranged to generate HTML files describing personalised menu pages to be transmitted to user set top boxes 7 in response to received user requests 215. Each user interface server 31 tries to generate these HTML files itself without having to pass the request 215 to the appropriate application server 30, in order to try to minimise the processing burden on the application servers 30 and on the database 39. The user interface server 31 is also responsible for carrying out common processing functions (such as user login, error handling etc.) which are required by two or more of the application servers 30.

As shown in FIG. 3, the user interface server 31 includes an interface unit 301 which is operable to interface the user interface server 31 to the IP data network 33 and to the load balancer 35. The interface unit 301 is operable to receive messages from the load balancer 35 and to pass them to a listening unit 303. The listening unit 303 is arranged to listen for user requests 215 transmitted from the user set top boxes 7 and to pass these to a request handling unit 305. The request handling unit 305 is responsible for validating the user making the request and for checking that the request is a valid one. The request handling unit 305 also checks to see if the user request can be dealt with by the user interface server 31 from data stored in an HTML cache 309-1 or an XML cache 309-2. The contents of these and other caches will be described in more detail later. If the request handling unit 305 determines that the necessary information for responding to the user request 215 is stored within the HTML or the XML caches 309, then the request handling unit 305 passes the cached information directly to a response handling unit 307 which uses this cached information to generate a personalised HTML file which it outputs back to the user set top box 7 via the interface unit 301 and the IP data network 33.

If the request handling unit 305 determines that the user interface server 31 cannot respond directly to the user request 215, then it determines which application server 30 the request 215 is to be directed and then retrieves appropriate user information from a user data cache 310 that will be required by that application server 30 to respond to the user request 215. At the same time, the request handling unit 305 also determines if any common functions (such as user login) are to be performed and if so, it instructs a common functions processor 311 to carry out the appropriate common function and return the result. The request handling unit 305 then passes the original user request 215 together with the additional user information retrieved by the request handling unit 305 to the appropriate application server 30 via an interface unit 313. After the application server 30 has processed the request 215 (and retrieved appropriate information from the database 39 if necessary), the application server 30 returns an XML (extended markup language) file which identifies the information to be displayed to the user. As those skilled in the art will appreciate, an XML file only describes the information that is to be displayed, it does not describe how it should be displayed (i.e. the format and layout). This formatting information is provided, in this embodiment, by style sheets (not shown), some of which are stored in an XSLT cache 309-3, with the remainder being stored in a hard disk 315.

In this embodiment, when the response handling unit 307 receives an XML file from one of the application servers 30, it stores the XML file in the XML cache 309-2 and combines it with the appropriate style sheet from the XSLT cache 309-3 or the hard disk 315, to generate an HTML file which is stored in the HTML cache 309-1. The response handling unit 307 then uses data from the user data cache 310 to personalise the HTML file which it sends back to the appropriate user set top box 7 via the interface unit 301 and the IP data network 33. As shown in FIG. 3, the response handling unit 307 can also invoke the common functions performed by the common functions processor 311. This therefore allows application servers 30 to be able to trigger one of the common functions, such as the user login function by returning an appropriate instruction to the response handling unit 307.

A brief description has been given above of the operation of the user interface server 31 used in this embodiment. A more detailed description will now be given of the main components of the user interface server 31.

Caches

In this embodiment, one of the goals of the user interface server 31 is to try to reduce the number of user requests 215 that are passed on to the application servers 30 by, wherever possible, responding to the user's request 215 using data from caches within the interface server 31. As discussed above, the user interface server 31 includes a user data cache 310, an HTML cache 309-1, an XML cache 309-2 and an XSLT cache 309-3. The type of data stored in each of these caches will now be explained.

User Data Cache

The user data cache 310 stores all of the user information that is available in the database 39 for each user of the system 1. In this embodiment, this equates to approximately 500 bytes of data for each user. This data includes, among others, the user name, user age, user login name, user PIN (personal identification number), user set top box type, session ID, user login status bit, user subscription level, user family name, user set top box ID, current television channel or video programme being viewed, user E-mail address, user language, user background colour and other user preferences.

HTML Cache

The HTML cache 309-1 caches various HTML files that define the content and layout of menu pages. In this embodiment, there are essentially two different types of HTML file cached in the HTML cache 309-1—static HTML files and dynamic HTML files. The static HTML files describe menu pages or parts of menu pages which are the same for all users. For example, the HTML file describing the initial menu screen that shows the various options that are available will be common to all users (except for minor user personalisations which can be made when the file is about to be downloaded to the user). The dynamic HTML files that are stored in the HTML cache 309-1 are generated by the response handling unit 307 from an XML file received from, for example, an application server 30. These dynamic HTML files therefore describe menu pages showing menu data which may be specific to the particular user (for example illustrating the favourites of that user). In this embodiment, each dynamic HTML file is cached for a predetermined period of time (such as 500 seconds) defined by an application server 30.

XML Cache

The XML cache 309-2 stores XML files either generated from the common functions processor 311 or from the application servers 30. As mentioned above, XML files define the information that will be displayed in a menu screen but not the layout of that information on the menu screen. For example, the XML file may identify the programme listings for a selected TV channel for today. Since this information is likely to be requested by other users, the user interface server 31 caches this XML file in the XML cache 309-2. In this way, for example, if another user wishes the same information but requires a different style sheet to generate the HTML file (because, for example, they have a different type of set top box 7 or television 5), then the user interface server 31 does not have to obtain the same XML file from the application server 30 again. It can simply retrieve the XML file from the XML cache 309-2 and transform it into the appropriate HTML file using the appropriate style sheet for the other user.

XSLT Cache

In this embodiment, the XSLT cache 309-3 stores the style sheets which are used to generate the HTML files from the XML files. In this embodiment, there are five different classes of style sheet

i) a “form” style sheet in which one or more text boxes are provided for allowing the user to input text;

ii) a “carousel” style sheet in which the user can scroll through menu options;

iii) a “short electronic programme guide” style sheet which is used to provide programme information relating to a current television channel to the user;

iv) a “bill” style sheet which is used to provide detailed billing information to the user; and

v) a “mail” style sheet which is used to provide E-mail information to the user.

In this embodiment, there are several different style sheets in each class, which are used to cater for different web browsers 203 and user settings (such as widescreen/narrowscreen, PAL/NTSC etc.). As those skilled in the art will appreciate, the task of combining the XML file with the style sheet to generate the HTML file can be relatively time-consuming (of the order of 200 milliseconds). In this embodiment, the style sheets are stored within the XSLT cache 309-3 in a pre-processed format which makes them easier to combine with the XML file.

Intelligent Caching

One of the possible problems with using caching techniques such as those used in the user interface server 31 is the possible storage requirements if user-specific HTML pages are to be cached. In particular, a system operating with U users, each caching P pages of size S will require storage of order U×P×S, which will grow large as the number of users, number of pages or complexity of each page increases.

In order to minimise the storage requirements, in this embodiment, an intelligent caching technique is used which distinguishes, for any given HTML file, which content is static (e.g., common to all users) and thus only needs to be stored once and which content is dynamic (e.g., user-specific) and hence needs to be stored on a per-user basis. In this embodiment, this is achieved by providing delimiters in the style sheets which indicate which sections of their output are static and which are dynamic. The caching then proceeds as follows:

i) The first time a user requests a specific page (such as the programme listing for a given channel on a given day), the generated HTML page will be processed and separated into its static and dynamic portions using the delimiters inserted into the style sheet.

ii) The static portions are then stored in a static data store within the HTML cache 309-1 and the dynamic portions for the particular user are stored in a dynamic data store within the HTML cache 309-1.

iii) When a second user requests the same page, the HTML file will again be generated but only the user-specific dynamic portions will be stored in the HTML cache 309-1—the static portions will be the same as those stored during the request of the first user and therefore do not need to be stored.

iv) When a user who has already requested the page requests it again, the cached page will be reconstructed by combining the static portion and the user-specific dynamic portion, thus recreating the user's page from the HTML cache 309-1, without the entire contents of the page being stored for each individual user.

Variable Swapping

In order to improve the efficiency of the caching system used in this embodiment, the user interface server 31 supports a technique known as post-parse interpolation (which is referred to herein as variable swapping). This is designed to allow minor user-specific page customisations such as a change in background colour or the addition of the user name to the menu screen, to be applied to the HTML file after it has been generated using the style sheet and the XML file. It is the use of this variable swapping technique that allows the system to be able to store static HTML files for all users whilst at the same time being able to personalise the HTML files for individual users at serve time (i.e. at the time it is downloaded to the user). In this embodiment, this is achieved by the response handling unit 307 which swaps specific user data into the HTML file at the time that it is about to be downloaded to the user set top box 7, using a variable swapping algorithm. These variables are referred to as hash-hash variables because they are represented in the style sheet as ##variable_name##, and are swapped using an efficient process that is much faster than the style sheet/XML transformation process.

Whenever a substitution of this sort is to be made, a placeholder of the form ##variable_name## is inserted into the style sheet or XML file so that it appears in the resulting HTML file. At serve time, the corresponding variable for the user is retrieved from the user data cache 310 and inserted into the HTML file.

In this embodiment, the same variable swapping technique is also used to swap in machine constants associated with the user interface server 31, into generic XML files received from the application servers 30. In particular, since the application servers 30 can transmit XML files to different user interface servers 31, they use placeholders within the XML file to identify constants that are specific to the user interface server 31. When the response handling unit 307 receives a generic XML file having such a placeholder, it swaps in the appropriate constants that are specific to that user interface server 31. For example, the XML file may refer to a particular icon that is to be downloaded with the menu page to the user set top box 7. The directory location that this icon is stored may be different on each of the user interface servers 31. Therefore, by inserting the name of the icon within the ## delimiters, the response handling unit 307 can replace the icon name with the correct storage location for the icon on that user interface server 31.

Request Handling Unit

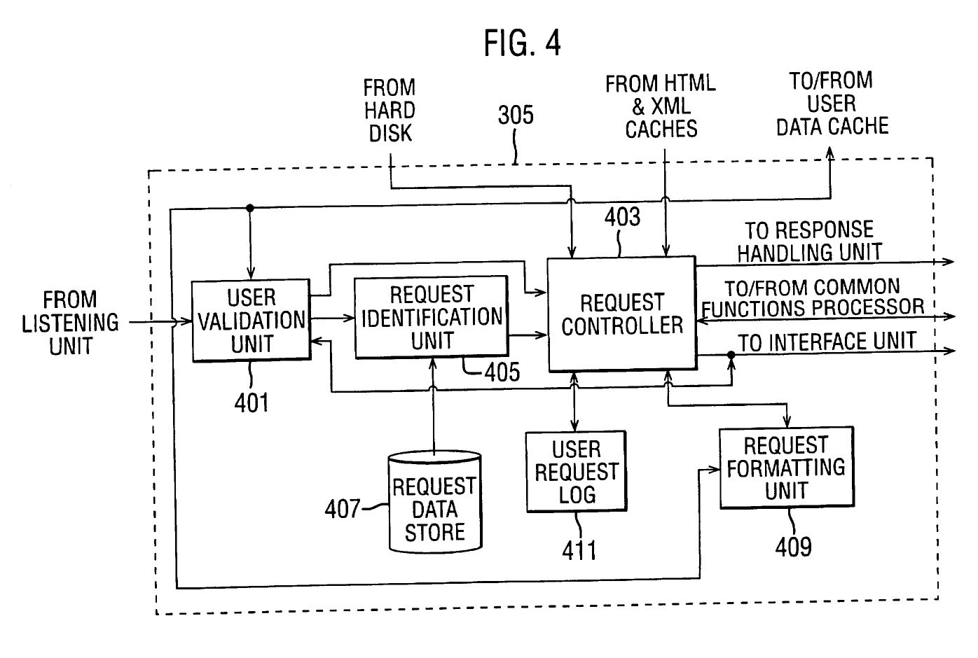

The main components of an exemplary request handling unit 305 are schematically shown in FIG. 4. As shown, user requests 215 received from the listening unit 303 are initially passed to a user validation unit 401 which checks that the user ID 225 in the received user request 215 is the user of the set top box 7 that is currently logged into the system. The user validation unit 401 does this by checking a log-in status bit for that user stored in the user data cache 310. The user validation unit 401 also checks that the current session ID 227 in the user request 215 matches that stored in the user data cache 310 for that user. If it is not, then the user validation unit 401 flushes the data stored in the user data cache 310 for that user and refreshes the user data cache 310 with corresponding data which it retrieves from the database 39 via the interface unit 313.

If there are any problems with the user's logged in state, then the user validation unit 401 informs a request controller 403 which outputs data to the response handling unit 307 to cause a menu page to be transmitted back to the user's set top box 7 requesting the user to confirm their PIN number. Once the user validation unit 401 has confirmed that the user is a valid user, the received user request 215 is passed to a request identification unit 405 which checks that the received user request 215 is a valid request. The request identification unit 405 does this by comparing the application identifier 229 and the screen identifier 231 with request type data stored in the request data store 407. If the received application identifier 229 and screen identifier 231 do not match any of the entries in the request data store 407, then the request identification unit 405 passes the received request 215 to the request controller 403 and informs it that the received user request 215 is invalid. In response, the request controller 403 outputs an appropriate response to the response handling unit 307 in order to cause an error page to be sent back to the user's set top box 7.

In this embodiment, each application identifier 229 stored in the request data store 407 is stored together with data that identifies the application server 30 which can service the user request. Therefore, if the request identification unit 405 matches the application identifier 229 of the received user request 215 with an entry in the request data store 407, it retrieves the corresponding data identifying the application server 30 which can service the user's request and forwards the user request 215 together with this application server data to the request controller 403.

Upon receiving a valid user request 215 from the request identification unit 405, the request controller 403 checks whether or not the user interface server 31 can service the request 215 from data stored in the HTML cache 309-1 or, if not, the XML cache 309-2. If the request controller 403 determines that the necessary information for servicing the user's request is stored in either of these caches, then it retrieves the appropriate HTML file or XML file from the cache and passes it directly to the response handling unit 307. If the information necessary for servicing the user's request is only stored in the XML cache 309-2, then the request controller 403 also identifies the appropriate style sheet class that should be used to convert the XML file into the appropriate HTML file. In this embodiment, the request controller 403 obtains this data identifying what style sheet class should be used from a file stored in the hard disk 315 that relates XML files to an appropriate style sheet class.

If the request controller 403 does not find the appropriate HTML file or XML file in the caches, then the request controller 403 checks to see if the user's request 215 relates to a system common function such as a user login, errors, alerts, user favourites, user searches etc. If it does, then the user's request 215 is passed to the common functions processor 311 which, as will be described below, performs the required common function.

In this embodiment, if the request controller 403 determines that the received user request 215 is to be forwarded to an application server 30, then before doing so, it initially passes the user request 215 to a request formatting unit 409. The request formatting unit 409 retrieves additional user information from the user data cache 310 which will be needed by the application server 30 that will service the request. In this embodiment, what additional information each application server 30 will require is preprogrammed in advance within the request formatting unit 409. For example, each of the application servers 30 may require a different user ID and password before it will provide the requested service or content to that user. In this case, the request formatting unit 409 would retrieve the appropriate user ID and user password from the user data cache 310 and would add them to the user request 215. The request formatting unit 409 can also add other information such as: the user's age, the type of set top box 7 that the user is using, the type of television 5 that the user has, the user's E-mail address, the user's preferred language and other user preferences. Once the request formatting unit 409 has added the appropriate information to the user request 215, it returns the processed user request back to the request controller 403, which forwards the processed user request to the appropriate application server 30 via the interface unit 313.

In this embodiment, each time the request controller 403 receives a user request 215 from either the user validation unit 401 or the request identification unit 405, it logs the request 215 within a user request log 411 together with details of the user, the resource requested, the time, any error information etc. This information is then passed from time to time to the management and billing server 29 which monitors all the requests that have been made and adapts user profiles accordingly.

Common Functions Processor

As mentioned above, the user interface server 31 uses the common functions processor 311 to carry out processing functions on user requests 215 that would be required in two or more of the application servers 30. As a result, it is not necessary to separately implement these functions in these application servers 30. Another advantage of implementing these common functions within the user interface server 31 is that once the software defining the functions has been written, they can be used by current application servers 30 and any future application servers 30 which may be added to the system 1. The common functions that the common functions processor 311 can perform in this embodiment will now be described.

Errors

One of the common functions provides an error handling mechanism to the user interface server 31. This error common function allows application servers 30 to return error codes which can then be formatted by the user interface server 31 into the appropriate error page for the user to whom the error message is to be sent. When the requested application server 30 returns an error code to the response handling unit 307, the error code is passed to the error common function within the common functions processor 311, which returns an appropriate XML file which identifies the error message to be displayed to the user. The response handling unit 307 then combines this XML file with an appropriate style sheet (as described above) in order to generate the appropriate HTML error page for downloading to the user set top box 7. By using different error message style sheets and the above described variable swapping techniques, the user interface server 31 can generate different error pages for different groups of users (grouped for example on the basis of language, age etc.).

Some example error codes and the corresponding message are given below in the following table:

| CODE | NAME | DESCRIPTION |
|---|---|---|
| TAS 100 | internal server | there was an error whilst processing the |
| | error | request on the application server and a |
| | | fault message is returned stating the error |
| TAS 200 | must understand | the request contained an element that the |
| | | application server did not understand |
| TAS 300 | invalid request | the request was invalid because it was |
| | | missing relevant information |
| TAS 400 | application | the application server was able to under- |
| | faulted | stand the request, but an error occurred |
| TAS 500 | database error | there was an error whilst the application |
| | | server was accessing the database |

Alerts

In this embodiment, an alerts common function is provided which is used to notify users when one of the application servers 30 (such as the mail server 19) needs their attention, when the user is using a different application server 30 (such as the broadcast TV server 27). This alerts common function can be used, for example, to give the following types of alerts: that there is a new E-mail message for the user; that a favourite television programme is currently showing on a different channel; that the user has missed a favourite television programme but that it has been recorded for the user if they wish to view it now etc. The alerts function can also be used to advise the user during the playing out of a television programme or video that additional information on the programme or video is available. The additional information may, for example, be links to E-commerce sites where additional information about the programme or film may be available or where merchandise relating to the film can be purchased. In this embodiment, the alerts common function can be programmed for each of the users so that if a user does not want to receive any alerts then they will not get any.

The alerts common function is designed to operate using an alerts table (not shown) in the database 39. If an application server 30 wishes to send an alert to a particular user, then it writes, within the alerts table in the database 39, the alert type, the user ID, the alert message and the link that the user should go to. Any new alerts added to the alerts table are also marked as being new. The alerts common function then processes the alerts table in the database 39 on a regular basis to see if there are any new user alerts and to see who they are for. If any new alerts are found, then the alerts common function outputs an appropriate XML file which causes the response handling unit 307 to send an alert to the appropriate user set top box 7. In addition, the alerts common function writes a confirmation message to the database 39 indicating that the alert has been sent.

In this embodiment, if the set top box 7 is currently showing a TV channel or is playing a video when it receives an alert message, then the web browser 203 in the set top box 7 generates a symbol which it overlays onto the television screen. If the user does not acknowledge the alert after a predetermined period of time, then the web browser 203 removes the symbol from the screen. If the user responds to the alert then the web browser 203 displays details of the alert on the television screen. The user can then ignore the alert or they can go to the link associated with the alert.

If, however, the set top box 7 is currently displaying a menu screen to the user when the alert message is received, then, in this embodiment, the alert symbol is displayed on the left-hand side of the menu frame. Again, the user can either ignore the alert or the user can select it in order to determine what the alert is and whether or not to proceed to the link associated with the alert. As those skilled in the art will appreciate, when the user is scrolling through the menu pages, the web browser 203 must ensure that the alert symbol is displayed on successive menu pages so that the user has time to see the symbol. Otherwise, the alert symbol will be overwritten the next time a menu page is downloaded from the user interface server 31.

As those skilled in the art will appreciate, without such an alerts common function being provided in the user interface servers 31, each of the application servers 30 would have to manage such a messaging system directly with each of the user set top boxes 7. However, since all of the menu pages are produced by the user interface server 31, alerts can be raised and provided to the user with the next outbound menu page regardless of the application server 30 which instructed the alert message.

Login

A login common function is provided within the common functions processor 311. This common function is used to log new users in and out of the system. Application servers 30 can also trigger the login common function, for example, in order to verify a user's identity when the user is purchasing an item. The login function validates the user by comparing a user PIN number input by them with the user PIN number stored in the database 39.

Whenever a new user is logged into the system 1, the login common function also generates a new session ID 227 for that user which it stores in the database 39. The login common function also amends the data for the previously logged-in user to indicate that he has logged out. In order to ensure that the user data stored in the user data cache 310 is kept up to date, the login common function also regularly refreshes the user data cache 310 from the database 39. Additionally, when the login status of any users are updated within the database 39, the database triggers the updating of the appropriate user data within the user data caches 310 in all of the user interface servers 31. This dual process of refreshing the user data cache 310 ensures that a change in the logged-in status of any user is reflected throughout the entire system 1.

In this embodiment, the login common function also controls the parental controls offered by the system 1. In particular, the login common function also allows the subscription holder the ability to set rules over what videos, television channels and content other users of the same set top box 7 may view. This subcomponent of the login common function can make changes to parental control settings within the database 39 which are subsequently used by application servers 30 when a user makes a request to which they relate. In this way, the application servers 30 can tailor the content or services returned depending on the user's age and on the parental control settings etc.

As those skilled in the art will appreciate, running the login common function and the parental controls common function on the user interface server 31 and not on the set top box 7 provides enhanced system security since user's cannot hack in to change the system settings.

Favourites

In this embodiment, the common functions processor 311 also includes a favourites common function which is designed to maintain and store each user's personal favourites in one location within a favourites table (not shown) in the database 39. For example, if a user marks a TV programme as a favourite, then the favourites common function stores this information in the database 39 so that this information is available for use by the application servers 30. The favourites common function has two main routines, one for adding favourites to the favourites table in the database 39 and one for viewing the favourites from the favourites table in the database 39.

Search

Another common function provided by the common functions processor 311 is a search common function which is designed to allow users to search for content and/or services across different application servers 30. For example, the search common function may be invoked to try to find everything to do with a particular actor and to return the results to the user. In this embodiment, when the search common function is invoked it causes a menu page having a text box (in which the user can enter a search string) to be downloaded to the user set top box 7. In this embodiment, various search options can also be selected in order that the search be restricted to: programme titles, actors, directors, programme categories, programme descriptions or any of these. Upon receiving the user's response to this menu page, the search common function invokes a search in each of the application servers 30, and then combines the results and presents them back to the user as a unified set of search results that the user can scroll through and select. Alternatively, the search may be restricted to just one or a few of the application servers 30.

Response Handling Unit

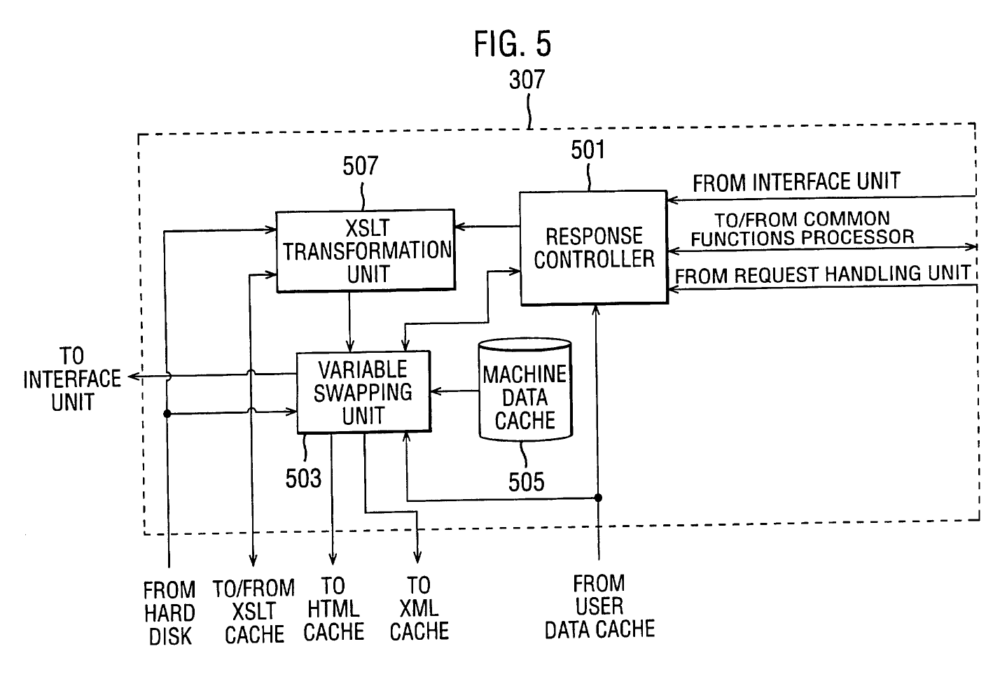

As discussed above, the purpose of the response handling unit 307 is to generate the appropriate personalised HTML file for the next menu page to be downloaded to the user set top box 7. FIG. 5 shows in more detail exemplary main components of the response handling unit 307 used in this embodiment. As shown, the response handling unit 307 has a response controller 501 which receives XML files either from one of the application servers 30 via the interface unit 313; from one of the common functions being run on the common functions processor 311; or from the request handling unit 305 if the request handling unit 305 determines that the user's request 215 can be serviced from the data stored in the XML cache 309-2. The response controller 501 can also receive an HTML file from the request handling unit 305, if the request handling unit 305 determines that the user's request 215 can be serviced from data stored in the HTML cache 309-1.

In this embodiment, each XML file received from an application server 30 is returned together with data indicating that the XML file is cachable and for how long it is cachable. The returned XML file also includes data identifying the user to which the XML file relates. As discussed above, in this embodiment, the XML files that are received from the application servers 30 are designed to be generic in nature so that they can be used for servicing requests for the same menu page from other users. As discussed above, the XML file is also generic to the user interface severs 31. In this embodiment, the response controller 501 passes the generic XML file received from the application server 30 to a variable swapping unit 503 which uses data stored in a machine data cache 505 to swap generic user interface server data within the XML file with specific data for the particular user interface server 31 processing the XML file. The variable swapping unit 503 then returns the modified XML file back to the response controller 501 and caches it in the XML cache 309-2.

The response handling unit 307 also includes an XSLT transformation unit 507 which transforms the received XML file into an HTML file in accordance with the appropriate style sheet. The particular style sheet that is used to transform the received XML file is determined by the response controller 501. In particular, the XML file received from the application server 30 includes data identifying the class of style sheet that is to be used. The response controller 501 then retrieves user information from the user data cache 310 which identifies the type of set top box 7 the user has and other user settings, and uses this information to determine the exact style sheet from the identified class of style sheet to be used in transforming the received XML file into the HTML file describing the menu page. The response controller 501 then passes the received XML file to the XSLT transformation unit 507 and causes the correct style sheet to be passed to the XSLT transformation unit 507 from the XSLT cache 309-3.

As mentioned above, in this embodiment, not all of the style sheets are stored in this pre-processed form within the XSLT cache 309-3. In particular, only the most common style sheets are stored in this format within the XSLT cache 309-3. The remaining style sheets are stored in their native format within the hard disk 315. Therefore, if the response controller 501 determines that the required style sheet is not stored within the XSLT cache 309-3 then it causes the required style sheet to be passed to the XSLT transformation unit 507 from the hard disk 315. In performing the transformation process, the XSLT transformation unit 507 performs the appropriate pre-processing on the style sheet and then combines it with the XML file to generate the required HTML file. In this embodiment, the XSLT transformation unit 507 also stores this pre-processed style sheet into the XSLT cache 309-3 for a predetermined period of time or until it is overwritten by another pre-processed style sheet, in case it is needed again for processing a subsequent request from the same user.

As shown in FIG. 5, the resulting HTML file generated by the XSLT transformation unit 507 is passed to the variable swapping unit 503 which swaps in any user interface server constants from the machine data cache 505 and stores the resulting HTML page within the HTML cache 309-1. The variable swapping unit 503 also replaces any user ## variables within the HTML file with specific user data from the user data cache 310. In this way, the generated HTML file is personalised for the user who made the request, for example by changing the background colour screen for the menu page, adding the user's name to the page etc. The variable swapping unit 503 then outputs this personalised HTML file to the interface unit 301 for onward transmission to the appropriate user set top box 7.

The above description describes the operation of the response handling unit 307 when the XML file is received from one of the application servers 30. A similar procedure is carried out if the request handling unit 305 identifies that the user interface server 31 can service the user request from data within the XML cache 309-2. However, if the request handling unit 305 determines that the user request can be serviced from an HTML file stored in the HTML cache 309-1, then the cached HTML file supplied to the response controller 501 from the request handling unit 305 is passed directly to the variable swapping unit 503 (bypassing the XSLT transformation unit 507), where the appropriate user ## variables from the user data cache 310 are swapped in and then the personalised HTML file is output to the user in the same way.

As discussed above, the application server 30 can send an appropriate instruction to trigger one of the common functions. In this case, the response controller 501 activates the appropriate common function in the common functions processor 311 and receives an XML file back from it. For example, the application server 30 may trigger a request for the current user's PIN. In this case, the response controller 501 would activate the login common function which would generate the appropriate XML file for generating the login menu page. If the PIN number returned from the user is incorrect, then the request handling unit 305 can trigger the appropriate error page to be downloaded to the user. If the user is eventually validated then the request handling unit 305 can return an appropriate confirmation to the application server 30 which can then respond to the original user request.

Application Server

The application servers 30 receive user queries from the user interface servers 31 together with user details and information generated from any common functions which have been required to action the request. The application server 30 operates to deliver the user's requested service or menu page by processing the received request and data and by retrieving data relevant to the request from the database 39. In order to ensure optimum performance in the system 1 and to meet the goal of limiting the queries on the database 39, the application servers 30 are also designed, in this embodiment, to utilise efficient caching.

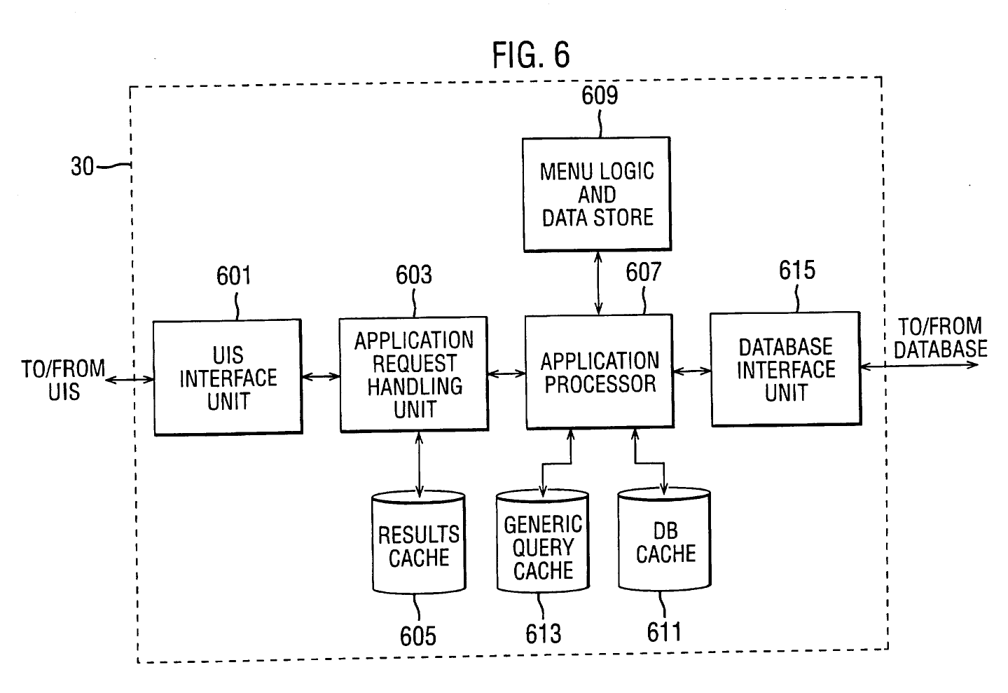

FIG. 6 is a schematic block diagram illustrating exemplary main components of one of the application servers 30. This block diagram has been shown in general form so that it is applicable to all of the application servers 30. As shown, the application server 30 includes a UIS interface unit 601 for interfacing the application server 30 to the user interface servers 31. The UIS interface unit 601 is operable to receive user requests 215 together with the added user information provided by the user interface servers 31 which it passes to an application request handling unit 603. The application request handling unit 603 processes the received data to determine: (i) if the request should be rejected; (ii) if the user request can be responded to from data stored in a results cache 605; or (iii) if the user request should be forwarded to an application processor 607. In particular, in this embodiment, the application request handling unit 603 checks to ensure that each user request that it receives is for that application server 30. It does this by checking the application identifier 229 forming part of the user request 215 with the application identifier associated with that application server 30. If these identifiers are different, then the application request handling unit 603 rejects the user request and returns an appropriate error code back to the user interface server 31.

As mentioned above, the application servers 30 generate XML files that describe the information to be inserted within a menu page. These XML files are designed to be generic in nature so that they can be processed by any of the user interface servers 31 and so that they can be used for servicing user requests received from other users. In this embodiment, the XML files generated for previous user requests are stored for a predetermined period of time in the results cache 605. Therefore, when the application request handling unit 603 receives a valid user request, it checks the XML files stored in the results cache 605 to determine if the XML file for responding to the user request is stored in this cache. If it is, then the application request handling unit 603 retrieves the XML file from the results cache 605 and returns it to the user interface server 31 that transmitted the user request. The application request handling unit 603 also informs the user interface server 31 that this XML file is cachable and for how long it is cachable. The XML file is also returned together with data identifying the user who made the request. In this embodiment, the application request handling unit 603 also passes the more generic XML files that are generated to the other user interface servers 31, also indicating that it is cachable and for how long it is cachable, so that these other user interface servers 31 can update their XML caches 309-2 accordingly.

If the application request handling unit 603 determines that it cannot service the user request from previously generated XML files stored in the results cache 605, the application request handling unit 603 passes the user request 215 and the other information received from the user interface server 31 to the application processor 607. In this embodiment, it is the application processor 607 that determines what service and/or what menu page the user is requesting. The application processor 607 does this using the screen identifier 231 forming part of the received user request 215 and data stored within a menu logic and data store 609. In particular, the menu logic and data store 609 stores data associated with each possible screen identifier which defines the information to be displayed in the next menu page together with menu logic defining what user selections can be made on that page. Therefore, when the application processor 607 receives a user request, it identifies the screen identifier 231 forming part of the received user request 215 and it retrieves the appropriate data and menu logic from the store 609. The application processor 607 then processes the retrieved data and the user data received with the request to determine what information it needs to respond to the request and to determine if it needs to retrieve any of that information from the database 39. If the application processor 607 determines that it does need to query the database 39, then it first checks a database (DB) cache 611 and a generic query cache 613 which store results of previous requests for data sent to the database 39. If the required information is not stored in these caches, then the application processor 607 formats an appropriate database query and outputs it to the database 39 via a database interface unit 615. When the application processor 607 receives the raw database data (such as the user favourites table) back from the database 39, it stores it in the DB cache 611. The application processor 607 then processes the returned database data to obtain the requested information (such as the favourites of a particular user) in a format suitable for returning to the user, which it stores in the generic query cache 613.

In this embodiment, the database cache 611 stores the data that is most frequently used by the application server 30 and is refreshed on a regular basis or when triggered by the database 39. When the data in the database cache 611 is updated in this way, the application processor 607 also reprocesses the data in order to refresh the data within the generic query cache 613. In this way, the data within these caches can be kept up to date for responding to subsequently received user requests.

After the application processor 607 has obtained the relevant information for responding to the user request, it passes the information together with the appropriate menu logic (defining allowed user selections and links therefor etc.) back to the application request handling unit 603. The application request handling unit 603 then packages the information and the menu logic into an XML file which it stores in the results cache 605 and returns to the user interface server 31 in the manner discussed above.

Management and Billing Server

Whilst the management and billing server 29 conforms with the above generic description, it is worth discussing in more detail its purpose within the system 1. In particular, the management and billing server 29 is operable to provide various user services such as user billing and user profiling. In this embodiment, the management and billing server 29 is also responsible for initially logging a user onto the system 1 and setting up the various user profiles and user tables within the database 39 for the new user. During this initial logon procedure, the user will provide the management and billing server 29 with details such as the user's age, password, E-mail addresses, spending limits, user name, world wide web home page, search page, user language, country etc. The management and billing server 29 is then responsible for creating the necessary user tables within the database 39 which in turn triggers the updating of the user data within the various caches within the system 1, in order to accommodate the new user.

The management and billing server 29 is also responsible for tracking payment of bills by the different users and for blocking the provision of services or content to users if they do not make payment.

In this embodiment, users can access the data maintained by the management and billing server 29 via the user interface server, for example, to identify what the outstanding amount owed by that user is or to identify the different films that have been purchased by that user in the current billing period.

In order to carry out the billing, the management and billing server 29 reads the user billing table (not shown) from the database 39, where all the application servers 30 write their transactions identifying what services and content have been delivered to the various users. The management and billing server 29 then calculates the appropriate amount for those services or content and adds it to the user's bill.

In this embodiment, the management and billing server 29 also monitors the different user requests that are received by the user interface servers 31 which are stored within the user request log 411 shown in FIG. 4. The management and billing server 29 then uses this information in order to determine user profiles for the different users of the system 1. For example, the management and billing server 29 can perform various statistical processings on the requests made by each user in order to try to identify the types of television programme or video films that the user likes. This user profile information can then be stored in the database 39 and used, for example, by the electronic programme guide server 21. In particular, the EPG server 21 may use this user profile information to make suggestions to a user as to the programmes he might wish to watch. The broadcast TV server 27 may also use this information in order to selectively record programmes for subsequent playout. In view of the amount of storage space required within the BTV server 27 to provide this facility, this service may not be provided to all users. For example, it may be provided only to “gold subscription” users so that they can watch programmes that they have missed.

Database

The database 39 is the single area of the system 1 where all the user's details, transactions and application data may be stored. The database 39 is responsible for maintaining this data and delivering it to the application servers 30 in a controlled manner. The database 39 is also responsible for notifying the application servers 30 and the user interface servers 31 when data within the database 39 has changed, so that the internal caches of the servers can be updated.

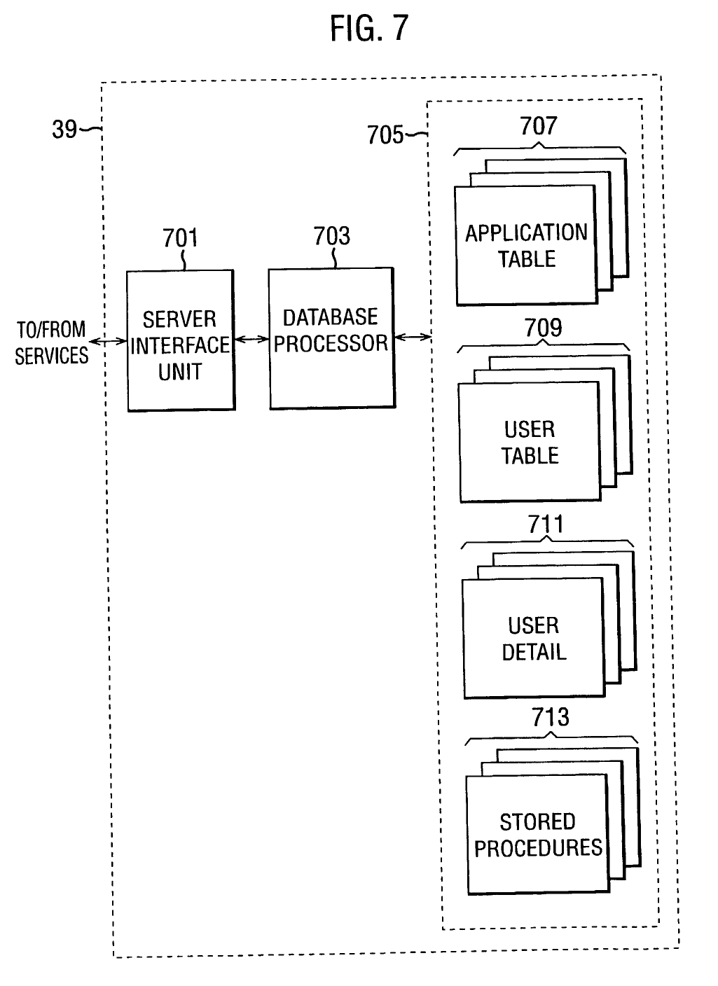

FIG. 7 is a block diagram illustrating exemplary main components in the database 39. As shown, the database 39 includes a server interface unit 701 which operates to interface the database 39 with the application servers 30 and the user interface servers 31. Database queries received from these servers are passed to a database processor 703 which processes data within database tables 705 to respond to the query. As shown in FIG. 7, the database tables 705 include a number of application tables 707 which store data relevant for the different application servers 30. For example, these tables store the electronic programme guide data that would be used by the EPG server 21 to generate programme guide listings. The database tables 705 also include user tables 709 which stores the various user information and details used by the application servers 30 and the user interface servers 31. This information includes, for example, the user name, user family name, user status, user login name, user login password, user login PIN, user E-mail address, user favourites, user language, user colour, user country, etc. The database tables 705 also include user detail tables for storing user account information, billing information and details of items purchased etc. Finally, the user database tables 705 also include a set of stored procedures 713 which can be invoked by a request from an application server 30 or a user interface server 31 in order to process some of the data within the database table 705. For example, the stored procedures may be used to process the electronic programme guide which provides programme listings for all channels available from the broadcast TV server 27, to determine the programmes that are playing now on a selection of the TV channels.

In addition to responding to queries received from application servers 30, the database processor 703 is also operable to transmit triggers to the various servers in order to refresh the caches within those servers. In particular, if an application server 30 or one of the user interface servers 31 writes data into the database tables 705, the database processor 703 generates appropriate triggers which it outputs to the other servers within the system 1 so that they can update the relevant parts of their caches. In this way, the database processor 703 can control the synchronisation of the cached data within the system 1.

A description has been given above of a system that allows users to gain access to services and content from a number of remote servers 30 via a user interface server 31. The user gains access to these services and content via a menu-based user interface in which the menu screens are generated within the user interface server 31 and downloaded to the user's set top box 7. A description will now be given of the menu-based user interface that is used in this embodiment.

User Menu System

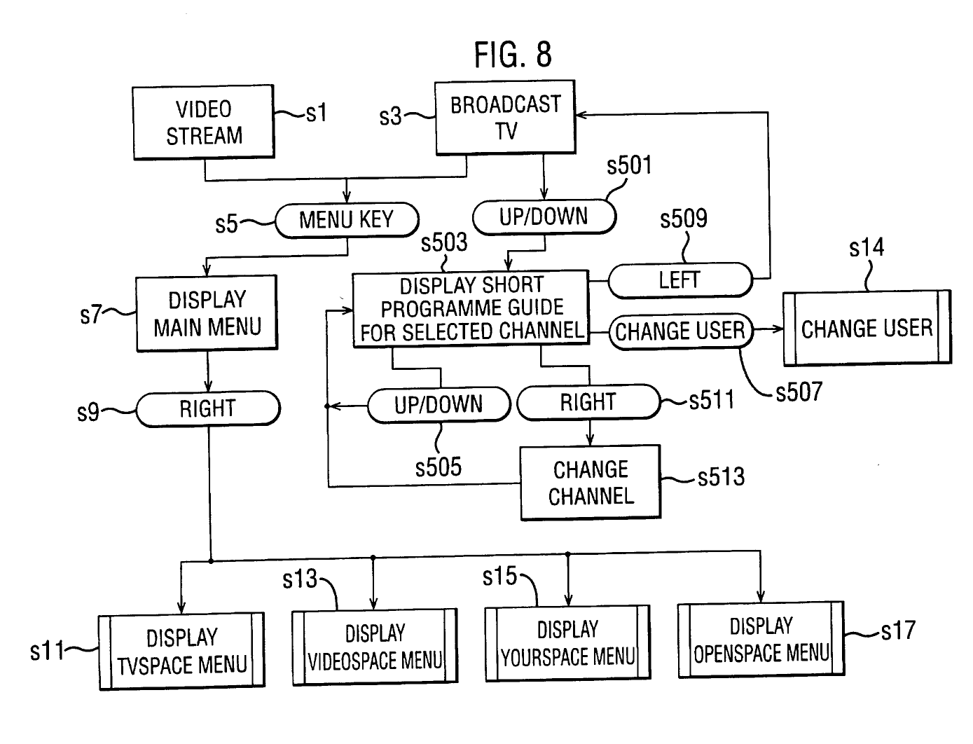

FIG. 8 is a functional flowchart illustrating an exemplary operation of the menu-based user interface used in this embodiment. Typically, before a user enters the menu system, they will either be watching a video stream (in operation s1) or a broadcast TV programme (in operation s3). In order to gain access to the menu system, the user presses (in operation s5) a menu key on the remote control 9 or the keyboard 11. In the following description unless otherwise stated, it will be assumed that the user is using the remote control 9 to navigate through the menu system.

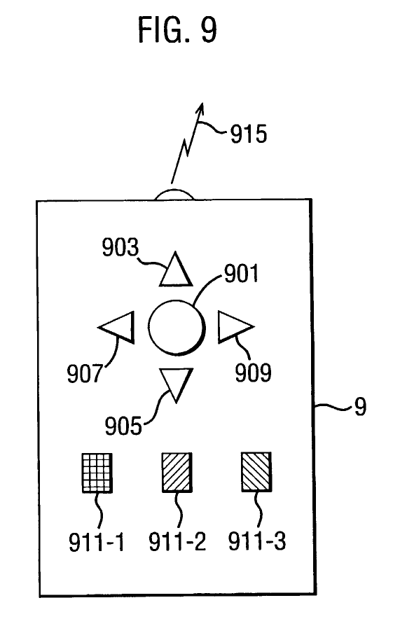

FIG. 9 schematically illustrates the remote control 9 used in this embodiment. As shown, the remote control 9 includes: a menu key 901, an up key 903, a down key 905, a left key 907, a right key 909 and three function keys 911-1, 911-2 and 911-3. The remote control 9 operates in a conventional way such that if a user presses one of the keys then a corresponding remote control signal 915 will be generated and transmitted to the set top box 7 which receives the signal and determines from it which key was pressed.

Returning to FIG. 8, if at operation s5 the user presses the menu key 901 while they are watching a video stream or a broadcast TV programme, then the main menu will be displayed in operation s7 on the television 5. In practice, what happens in this embodiment is that when the user presses the menu key 901, the set top box 7 generates a user request for the main menu screen. This request is transmitted to the user interface server 31 which generates the main menu screen from its local caches 309. As discussed above, the user interface server 31 personalises the menu screen for the user (for example in order to add the user's name to the menu screen, to change the background colour and to add the current time etc.) and then transmits it back to the set top box 7 for display on the television 5.

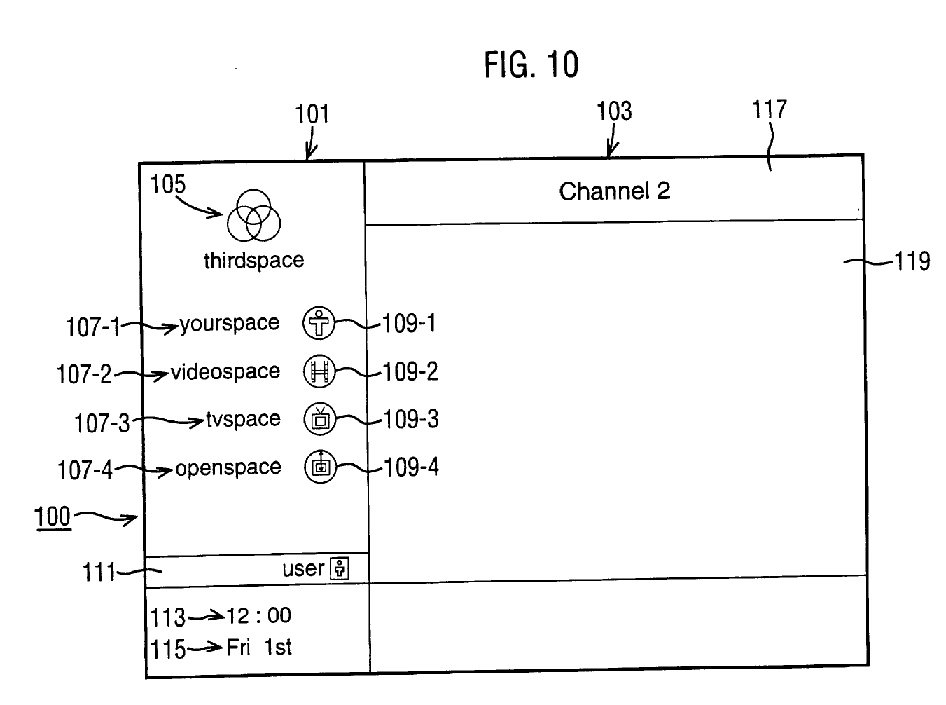

FIG. 10 illustrates the format of the main menu 100 used in this embodiment. As shown, the main menu 100 is split into two main parts—a left-hand frame 101 in which various menu categories 107 are presented to the user; and a right-hand frame 103 in which the video or broadcast television programme that the user was watching continues to play. The left-hand frame 101 includes an area at the top of the frame for displaying the name and logo 105 of the service provider that the user is subscribed to (in this case it is the name and logo of Thirdspace). Underneath the logo, there are four menu categories 107-1 to 107-4 to choose from, each having an associated icon 109-1 to 109-4 that is highlighted to identify the category that is currently selected. The left-hand frame 101 also includes an area 111 in which the name of the current user is displayed. Finally, at the bottom of the left-hand frame 101, the current time 113 and date 115 are displayed. In the right-hand frame 103, the name of the current broadcast television channel or the name of the film being shown is displayed in an upper part 117 and the television programme or video is played out in the central display area 119. In this way, the user can continue to watch the TV programme or video that was playing before the menu key was pressed.

By pressing the up key 903 or the down key 905 on the remote control 9, the user can change the menu category 107 that is currently highlighted. For example, referring to FIG. 10 again, the current menu category that is highlighted may be the Videospace category 107-2. If the user presses the up key 903 then the Yourspace menu category 107-1 would become highlighted. Alternatively, if the user had pressed the down key 905 then the TVspace menu category 107-3 would become highlighted. In this embodiment, in order to enter a menu category 107, the user presses the right key 909 on the remote control when that menu category 107 is highlighted. This is illustrated in FIG. 8 at operation s9. As shown in FIG. 8, the result is the displaying of the TVspace menu in operation s11, the Videospace menu in operation s13, the Yourspace menu in operation s15 or the Openspace menu in operation s17, depending on which menu category 107 was highlighted at the time.

In this embodiment, the TVspace category 107-3 provides the user with access to the services and content provided by the broadcast television server 27; the Videospace category 107-2 provides the user with access to services provided by the video server 15; the Yourspace category 107-1 provides the user with access to the world wide web via the web server 25, E-mail via the mail server 19 and their account information via the management and billing server 29; and the Openspace menu category 107-4 provides the user with access to shopping, classified adverts, local information and games via the shopping server 23.

A description will now be given of these different menu categories 107.

Tvspace

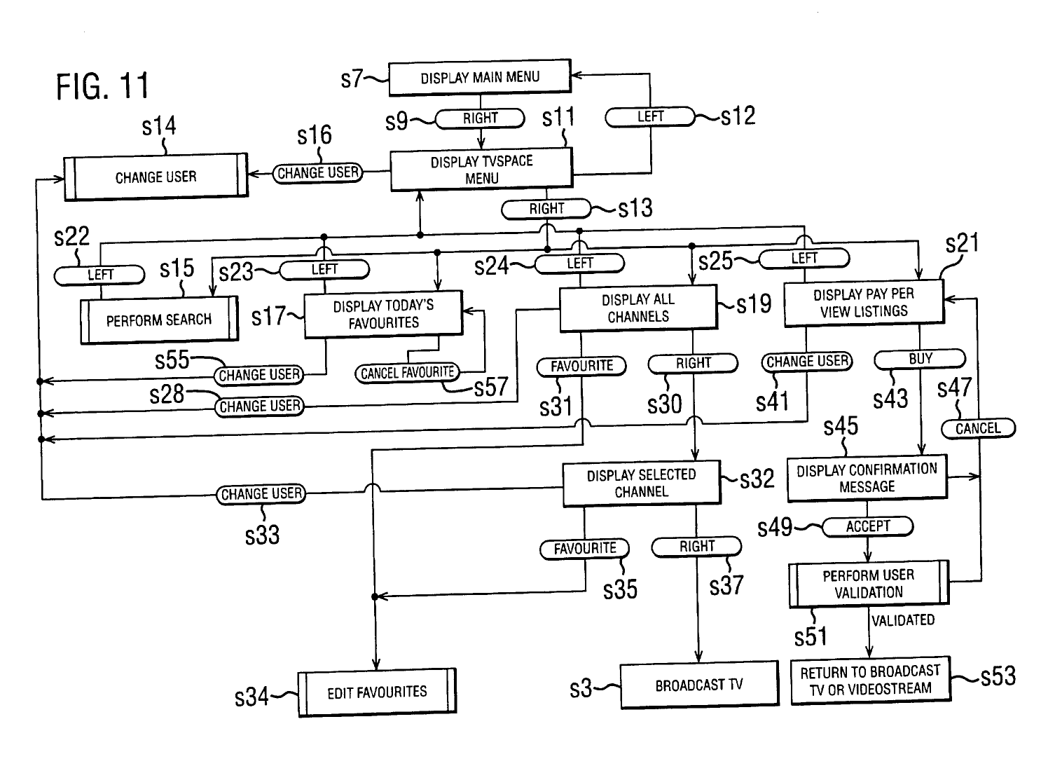

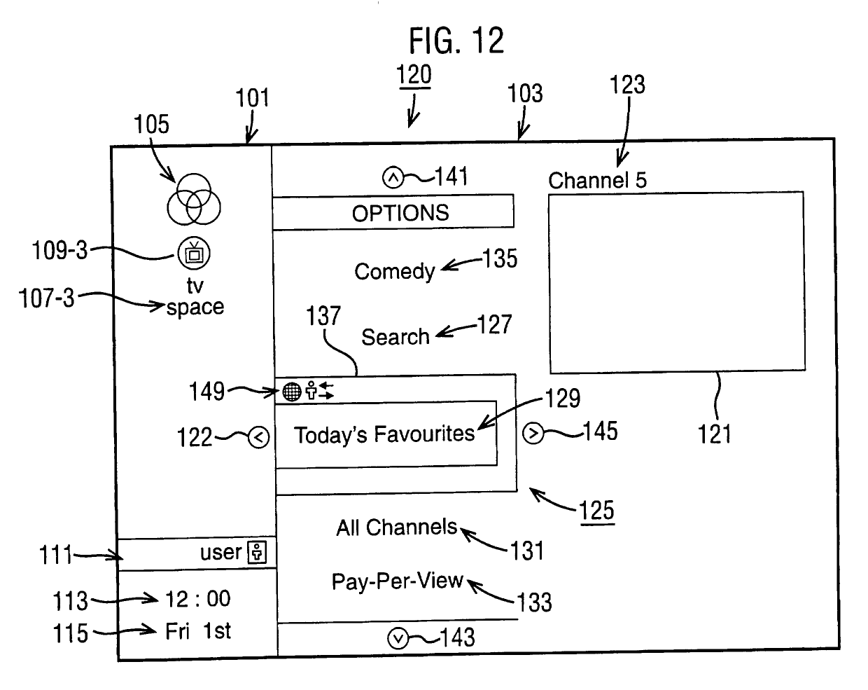

As mentioned above, TVspace 107-3 is the area of the user interface which allows the user to gain access to the services and content provided by the broadcast television server 27. FIG. 11 is a flowchart illustrating exemplary menu logic associated with TVspace 107-3. The display main menu operation s7 and the display TVspace menu operation s11 are shown again for clarity. The TVspace main menu 120 used in this embodiment is shown in FIG. 12. As can be seen from a comparison of FIG. 10 and FIG. 12, the TVspace main menu 120 has a similar look and feel to the main menu 100 shown in FIG. 10. In particular, it includes a left-hand frame 101 in which the service provider's logo 105 is displayed in an upper portion thereof. Underneath the logo 105 the menu category TVspace 107-3 is displayed to confirm to the user that they are in TVspace. The left-hand frame 101 also includes a left arrow icon 122, which indicates to the user that if they press the left arrow key 907 on the remote control 9, then they will be returned to the main menu 100 shown in FIG. 10. This option is illustrated in the flowchart of FIG. 11 at operation s12. The current user is also identified at 111 in the left-hand frame 101 together with the current time 113 and date 115.

The right-hand frame 103 of the TVspace main menu 120 includes a video window 121 in which the current television programme or video film continues to play. As shown, above this window 121 the name 123 of the film or channel currently playing is displayed to the user (in this illustration “Channel 5” is displayed). An “Options” carousel menu 125 is provided to the left of the video window 121 in which the different options for identifying a television programme to view are listed. In this embodiment, the main options available are: a Search option 127 in which the user can input a text string to search for a desired programme; a Today's Favourites option 129 which, if selected, lists any programmes that are on today and that the current user 111 has previously indicated as being favourite programmes; an All Channels option 131 which provides a full electronic programme guide listing for all of the television channels that the user has subscribed to (and is allowed to view); and a Pay-Per-View option 133 in which the user can browse through a listing of pay-per-view programmes that are available from the broadcast television server 27.

In addition to these main options, the TVspace main menu 120 also lists within the carousel 125 options that will be different for each user and which are specified by the service provider. In this example, a service provider defined Comedy option 135 is shown which, if selected, filters the full electronic programme guide data to identify programmes on all of the subscriber's channels which are comedy programmes. In order to view the comedy programme listings, the system operates as if the user had selected the All Channels option but with an appropriate filter to identify only programmes that have been classified as comedies. As those skilled in the art will appreciate, other service provider defined options may be available. In addition to the service provider defined options, the system may filter the options depending on the user profile. For example, an Adult option may be provided for users who are over 18. This option would be removed automatically from the options carousel for users who are under 18.

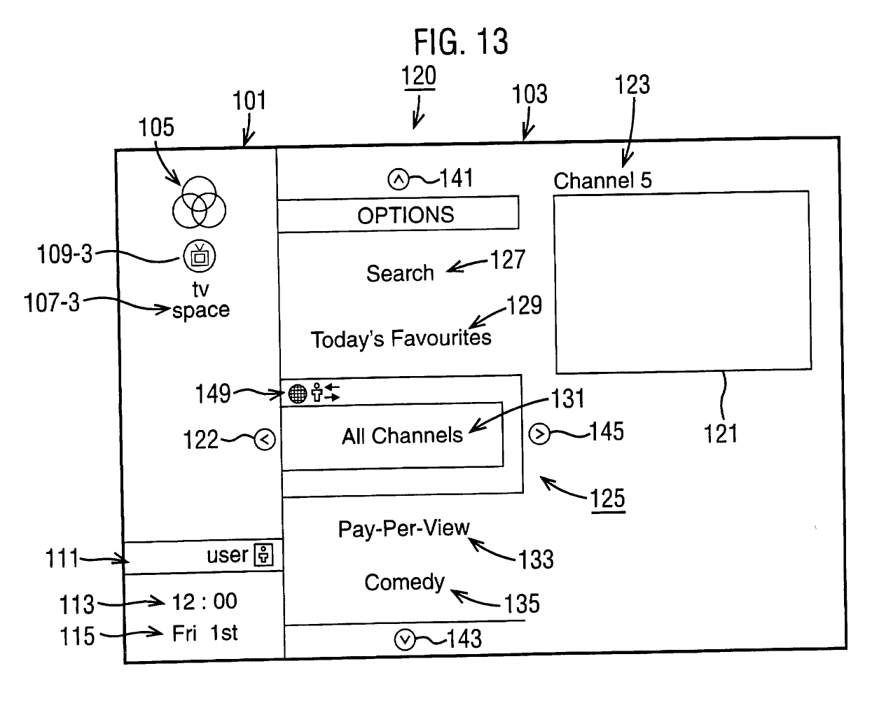

As shown in FIG. 12, the carousel 125 also has a selection window or box 137 in which one of the options is displayed at any one time. The user can scroll the different options through the selection window 137 (which remains fixed on the menu screen) using the up key 903 or the down key 905 on the remote control 9. This possibility is indicated to the user by the up arrow icon 141 and the down arrow icon 143 displayed at the top and bottom of the options carousel 125 respectively. For example, FIG. 13 shows the TVspace main menu 120 shown in FIG. 12 after the up key 903 on the remote control 9 has been pressed once. As shown, the options within the carousel 125 have all moved up one place, with the Comedy option 135 wrapping around to the bottom of the carousel 125. Therefore, by pressing the up key 903 or the down key 905 on the remote control 9, the user can position the desired option within the selection window 137. In this embodiment, when the user operates the options carousel 125, the web browser 203 amends the displayed menu screen without requesting an updated menu page from the user interface server 31. As those skilled in the art will appreciate, it does this under control of the Javascript instructions that are included within the HTML file describing the menu page.

As shown in FIG. 12, the selection window 137 includes a change-user icon 149 which can be activated by pressing the function key 911-1 on the remote control 9. This is illustrated in the flowchart shown in FIG. 11 by the change-user operation s14 which is accessed from the Tvspace main menu 120 by pressing the function key 911-1 in operation s16. A description of this change user option will be given later.

If the user presses the right key 909 on the remote control 9, the web browser 203 interprets this (using the links sent down with the HTML file describing the current menu page) as a desire to proceed with the option currently within the selection window 137 and it transmits a request for the appropriate menu page back to the user interface server 31. As shown in FIG. 11, when the user presses the right key 909 in operation s13, the Search menu is displayed in operation s15 if the Search option 127 was selected; the Today's Favourites menu is displayed in operation s17 if the Today's Favourites option 129 was selected; the All Channels menu is displayed in operation s19 if the All Channels option 131 was selected; or the Pay-Per-View menu is displayed in operation s21 if the Pay-Per-View option 133 was selected. If the user selects the Comedy option 135 then a Comedy menu will be displayed. This option is not shown in the flowchart of FIG. 11 since, in this embodiment, the Comedy option 135 corresponds to a filtered version of the All Channels option 131.

A more detailed description will now be given of these user options.

All Channels

As mentioned above, the All Channels option 131 provides the user with a full electronic programme guide for all of the channels to which the user has subscribed. In particular, when the user selects the All Channels option 131, the set top box 7 sends a request to the user interface server 31 for the electronic programme guide for the current user. Unless the user interface server 31 can provide the requested menu page from its caches 309, this request is passed to the electronic programme guide server 21. The electronic programme guide server 21 then filters the electronic programme guide data stored within the database 39 using the user profile information for the current user making the request. This filtering ensures that the user does not receive programme listings for channels that they have not subscribed to or for channels that they are not allowed to view. This programme listing information is then returned to the user interface server 31 which formats it into an appropriate HTML file and downloads it back to the user's set top box 7 which then generates the appropriate menu page.

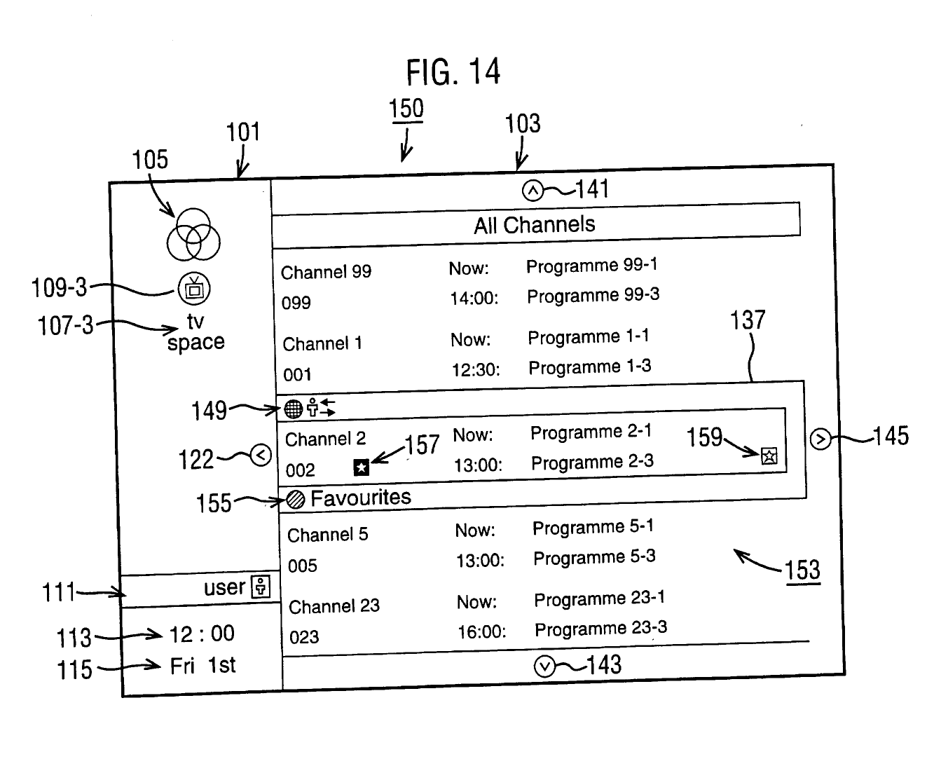

A typical All Channels menu page that is generated from this HTML file is shown in FIG. 14. As shown, the All Channels menu page 150 has a similar layout to the TVspace main menu 120 shown in FIGS. 12 and 13, in that it has the left-hand frame 101 and the right-hand frame 103. Again, within the left-hand frame 101 the system displays the service provider's logo 105 and underneath that the TVspace name 107-3 and logo 109-3. The left-hand frame 101 also displays the current user 111, the current time 113 and the date 115. Finally, the left-hand frame 101 also includes the left arrow icon 122 which indicates that the user can press the left arrow key 907 on the remote control 9 to return to the previous menu screen. This option is illustrated in the flowchart of FIG. 11 at operation s24.

In the right-hand frame 103, the menu page includes a carousel 153 which is entitled “All Channels” to confirm to the user that the carousel 153 is displaying all the channels that are available to the current user. As shown in FIG. 14, the carousel 153 is similar to the carousel 125 used in the TVspace main menu 120 shown in FIG. 12, except displaying what is on now and next on all of the television channels that the user has subscribed to. As shown in FIG. 14, the channels currently displayed are channel 99, channel 1, channel 2 (which is currently within the selection window 137), channel 5 and channel 23. As indicated by the up arrow icon 141 and the down arrow icon 143, the user can press the up key 903 or the down key 905 on the remote control 9 in order to scroll the available channels (not all of which may be displayed at once) through the fixed selection window 137.

As shown in FIG. 14, the selection window 137 includes the change-user icon 149. As discussed above, this option is selected by the user pressing the function key 911-1 on the remote control 9 and is illustrated in the flowchart shown in FIG. 11 at operation s28. In addition to being able to change the user from this menu page, the user can also add the current channel and/or one of the programmes within the selection window 137 to their list of favourites that are stored within the database 39. This option is represented within the menu page by the favourites icon 155 and is illustrated in FIG. 11 by the edit favourites operation s34 which is accessed from the All Channels menu page 150 by pressing the function key 911-2 in operation s31. A description of this edit favourites routine will be given later.

In this embodiment, the star icons 157 and 159 shown in FIG. 14 are used to indicate that channel 2 is currently a favourite channel and that the next programme on channel 2 (i.e. programme 2-3) is on the current user's favourites programme list.

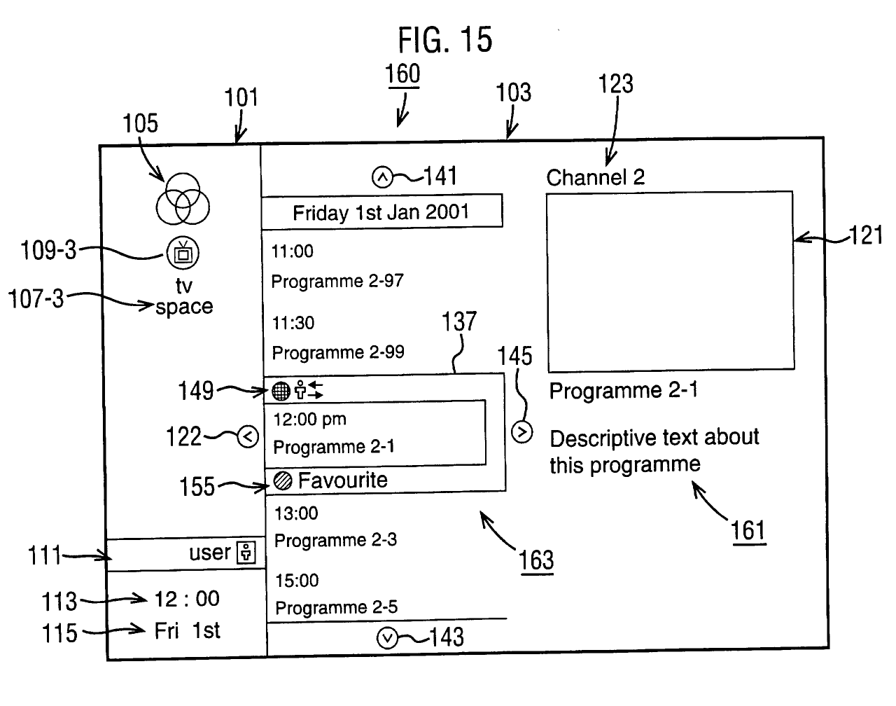

If the user presses the right key 909 on the remote control 9 (represented at operation s30 in FIG. 11), then the detailed programme listing menu page for the channel within the selection window 137 is retrieved from the electronic programme guide server 21 and displayed on the television 5 (which corresponds to operation s32 in FIG. 11). FIG. 15 illustrates the form of this detailed programme listing menu page 160 for channel 2. As shown, the detailed menu page 160 has the same general look and feel as the TVspace main menu 120 shown in FIG. 13. The same elements have been referenced with the same reference numerals and will not be described again. In this embodiment, when the user selects one of the channels from the previous screen, in addition to retrieving the detailed menu page 160 for that channel, the television programme currently showing on that channel is streamed to the user set top box 7 and played within the video window 121. The name of the channel 123 is also displayed above the video window 121 and beneath the window the name of the programme (in this case programme 2-1) is displayed together with a text description 161 of that programme.

In this embodiment, the detailed programme listing includes the details of programmes on the selected channel over the next seven days which are displayed in a carousel 163. Initially, when the user enters the detailed programme listing menu 160, the programme currently playing is shown in the selection window 137. The user can then scroll through the programmes that are on today and over the next seven days. When the programmes for the next day appear within the selection window 137, the date at the top of the carousel 163 is changed to the appropriate day. Further, as illustrated by the change-user icon 149 and the favourite icon 155, the identity of the user can be changed and the programme currently within the selection window 137 can be added to the user's favourite list. These options are selected at operations s33 and s35 in FIG. 11 respectively.

In this embodiment, if the user presses the right key 909 on the remote control 9 from this detailed menu page 160, then the menu page will be removed from the television screen and the programme currently being shown in the video window 121 will be expanded to fill the full television screen. This is illustrated in FIG. 11 at operations s37 and s3. The user must then press the menu key 901 again in order to re-enter the menu system.

Pay-Per-View

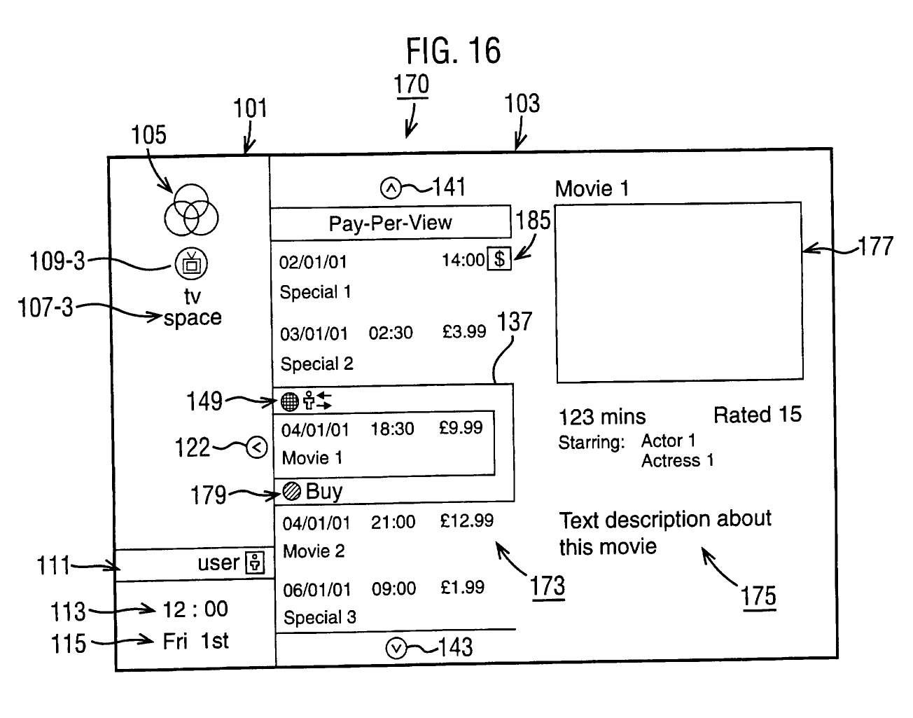

As mentioned above, the Pay-Per-View option allows the user to browse through a listing of pay-per-view television programmes and movies that are available from the broadcast television server 27. In particular, when the user selects the Pay-Per-View option 133, a Pay-Per-View menu page is displayed to the user on the television 5. A typical Pay-Per-View menu page 170 is shown in FIG. 16. As shown, the Pay-Per-View menu page 170 has the same general look and feel as the detailed menu page 160 shown in FIG. 15. The same elements have been referenced with the same reference numerals and will not be described again.

As shown in FIG. 16, the Pay-Per-View menu page 170 includes a “pay-per-view” carousel 173 in which pay-per-view programmes and films that will be broadcast within the next week are listed. Each pay-per-view programme or film listed in the carousel 173 identifies the date that the programme or movie will be shown, the time that it will be broadcast and the price that must be paid in order to receive the programme or movie. Any Pay-Per-View items already purchased are highlighted by a purchased icon 185 shown next to the item instead of the price.

As before, the user can use the up key 903 or the down key 905 on the remote control 9 in order to scroll the pay-per-view programmes and movies through the fixed selection window 137. As shown in FIG. 16, to the right of the selection window 137 the Pay-Per-View menu page 170 displays in text area 175 more details of the pay-per-view programme or movie currently within the selection window 137. In the illustration shown in FIG. 16, this includes details of how long Movie 1 lasts, the age rating for the movie together with details of the starring actors and actresses and a text description about the movie. As the user scrolls the different pay-per-view programmes and movies through the selection window 137, the information provided in this text area 175 changes to correspond to the programme or movie currently within the selection window 137. In this embodiment, a graphics window 177 is provided above this text area 175 in which a graphic picture is displayed for promoting the Pay-Per-View item currently within the selection window 137.

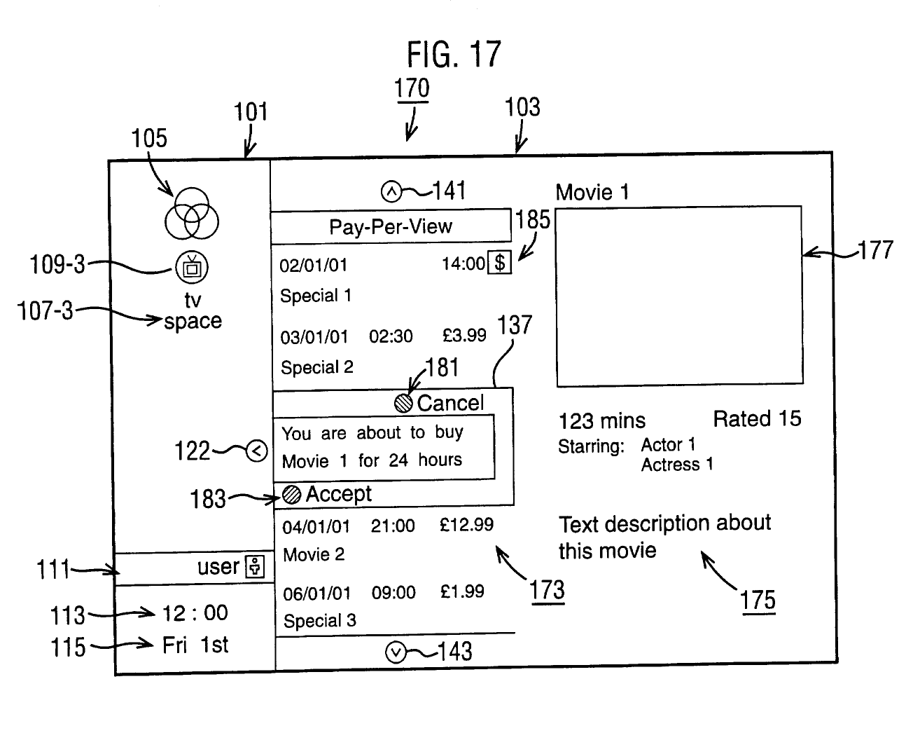

As shown by the change-user icon 149, it is possible to change the user in the Pay-Per-View menu page 170 by pressing the function key 911-1 on the remote control 9. This option is illustrated in the flowchart shown in FIG. 11 at operation s41. Additionally, the user can press the left key 907 on the remote control 9 to return to the TVspace main menu 120. This option is shown in FIG. 11 at operation s25. Finally, as illustrated by the buy icon 179, the user can buy the current pay-per-view programme or movie within the selection window 137. This option is shown at operation s43 in FIG. 11 and is activated by the user pressing function key 911-2. As shown in FIG. 11, if the user does buy the pay-per-view item, then at operation s45, a confirmation message is displayed to the user. This is shown in FIG. 17 which shows the Pay-Per-View menu page 170 with the confirmation message displayed within the selection window 137. As represented by the cancel icon 181 and the accept icon 183, the user can either cancel the operation and return to the Pay-Per-View menu page 170 shown in FIG. 16 or the user can accept that they are about to buy the selected pay-per-view item. In this embodiment, the user can cancel the operation either by pressing function key 911-3 or by pressing the left key 907 on the remote control 9 and they can accept that they are going to buy the selected pay-per-view item by pressing function key 911-2 on the remote control 9. These cancel and accept options are illustrated in FIG. 11 at operations s47 and s49 respectively.

If the user does accept to buy the selected Pay-Per-View item, then at operation s51, the system performs a user validation for allowing the user to buy the pay-per-view item. If the user is not validated then the user is returned to the Pay-Per-View menu page 170 shown in FIG. 16. If, however, the user is validated then the broadcast television server 27 indicates in the database 39 that the user has bought the selected pay-per-view item. If the pay-per-view programme or film is currently playing or is about to play, then the broadcast TV server 27 returns the user to the appropriate channel on the broadcast TV to receive the pay-per-view programme or film. However, if the pay-per-view programme or film is scheduled for playout at some time in the future, then the broadcast TV server 27 returns the user to the original broadcast TV channel or video stream that they were watching prior to entering the menu system.

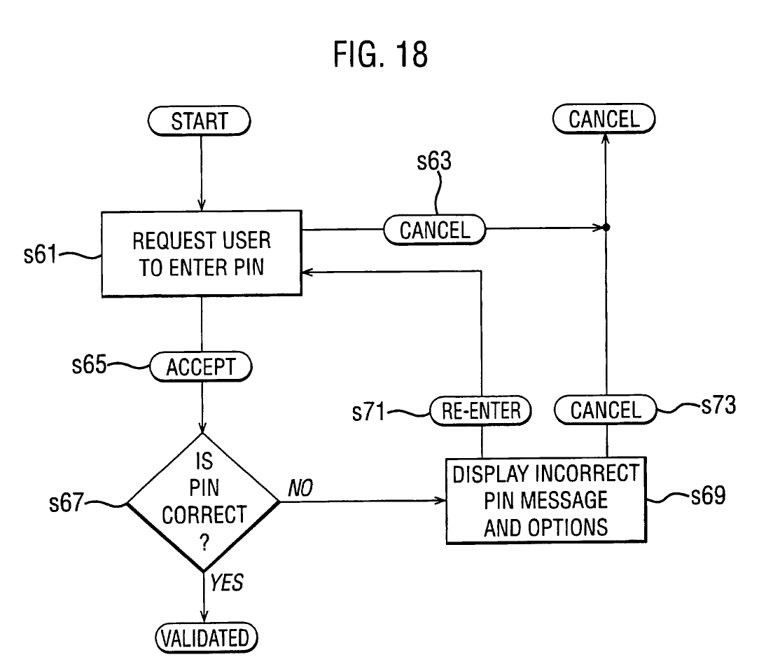

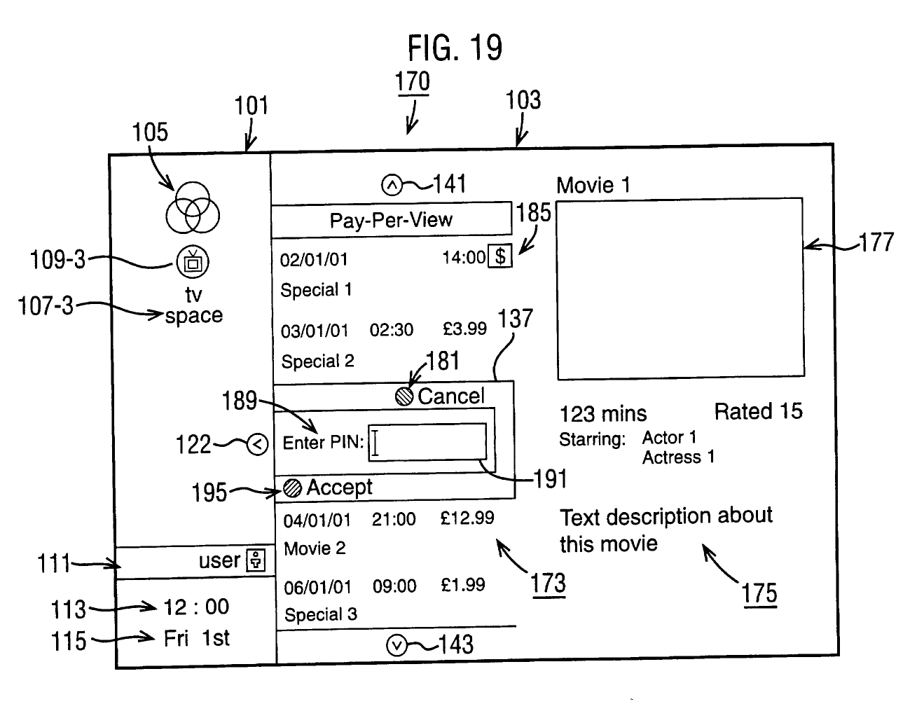

In this embodiment, in order to perform the user validation in operation s51, the user interface server 31 uses the login common function discussed above. The flowchart for this user validation routine is shown in FIG. 18. As shown in operation s61, when the login common function is initiated, the user is prompted to enter their PIN number. This is also illustrated in FIG. 19 which shows the prompt 189 for the PIN within the selection window 137 of the Pay-Per-View menu page 170. A text input box 191 is also provided within the selection window 137 in which the user can type (using the keyboard 11) their PIN number. At any time in the operation, the user can cancel the buying procedure by pressing the left key 907 on the remote control 9. Further, as represented by the cancel icon 181, the user can also cancel (in operation s63) the operation by pressing the function key 911-3 on the remote control 9. As represented by the accept icon 195, after the user has entered their PIN, the user accepts it by pressing (in operation s65) the function key 911-2 on the remote control 9. This causes the PIN number thus entered to be transmitted to the user interface server 31 where it is compared with the PIN number stored for the current user in the user data cache 310. This corresponds to operation s67 in the flowchart shown in FIG. 19.

If the PIN number is correct then the user is validated and the validation procedure ends. If, however, the PIN number is incorrect, then at operation s69 the user interface server 31 updates the menu page 170 to display an incorrect PIN message within the selection window 137 and to provide the user with the option of re-entering the PIN number or cancelling the operation. This is represented at operations s71 and s73 in FIG. 18. If the user decides to re-enter the PIN number, then the user is returned to the menu screen shown in FIG. 19 in which they can re-enter their PIN number. Otherwise, the user is returned to the original Pay-Per-View menu shown in FIG. 16. Although not illustrated in the flowchart shown in FIG. 18, the user is only allowed to re-enter their PIN number a limited number of times before the user interface server 31 aborts the buying operation and returns the user to the original Pay-Per-View menu shown in FIG. 16.

Today's Favourites

If the user selects the Today's Favourites option 129 from the TVspace main menu 120, then a request is sent to the user interface server 31 to retrieve all of the programmes that have been marked as being favourites for the current user that will be shown today. The results are then returned to the user and displayed to the user within an appropriate carousel (not shown). The user can then scroll through the favourites to determine if there are any programmes that the user wishes to watch. As shown in FIG. 11, when this favourites menu page is displayed in operation s17, the user has the option to press, in operation s23, the left key 907 on the remote control 9 in order to return to the TVspace main menu 120. They also have the option to change the current user (as represented by operation s55) or to cancel a favourite from the favourites list (as represented by operation s57).

Search

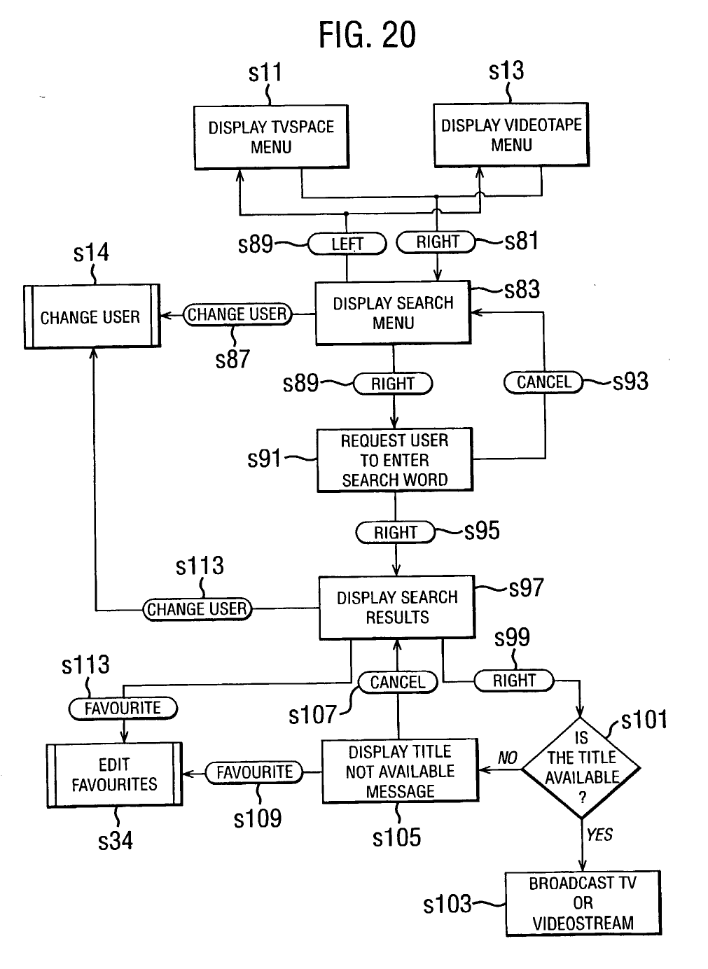

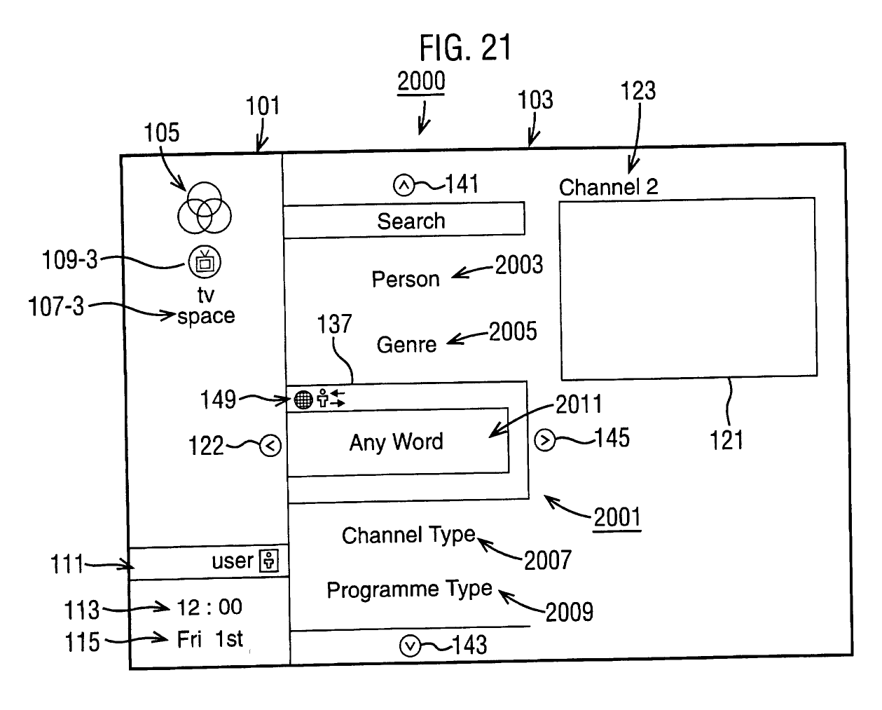

In this embodiment, the Search option 127 can be invoked either from the TVspace main menu 120 or from the Videospace main menu (to be described below). The flowchart illustrating the operation of the Search option 127 is shown in FIG. 20. As shown at operation s81, the user enters the search menu by pressing the right key 909 on the remote control 9 when the Search option is within the selection window 137. FIG. 21 illustrates a typical Search menu screen 2000 that is displayed at operation s83. As shown, the Search menu screen 2000 has the same look and feel as the TVspace main menu 120 shown in FIG. 12. The same elements have been labelled with the same reference numeral and will not be described again. As illustrated in FIG. 21, the search carousel 2001 identifies a number of different search options for narrowing down the search. These options include: a person option 2003 which can be used, for example, to search for a person's name; a genre option 2005 which can be used, for example, to search for programmes or videos based on their category (such as comedy, drama etc.); a channel type option which can be used, for example, to search for programmes on a particular type of channel (e.g. on a sports channel); a programme type option 2009 which can be used, for example, to search for particular types of programmes; and an any word search option 2011 which can be used to search for services and/or content based on a user-defined text string or word.

As in the previous menu screens, the user can scroll the search options through the selection window 137 until the desired search option is within the selection window 137, at which time the user can select that option by pressing the right key 909 on the remote control 9. This corresponds to operation s85 shown in FIG. 20. Further, as shown at operations s87 and s89, the user can be changed from the Search menu screen 2000 and they can return either to the TVspace menu or to the Videospace menu by pressing the left key 907. In this case, since the user can return to two different menu pages, the request transmitted back to the user interface server 31 identifies the previous screen that the user was in.

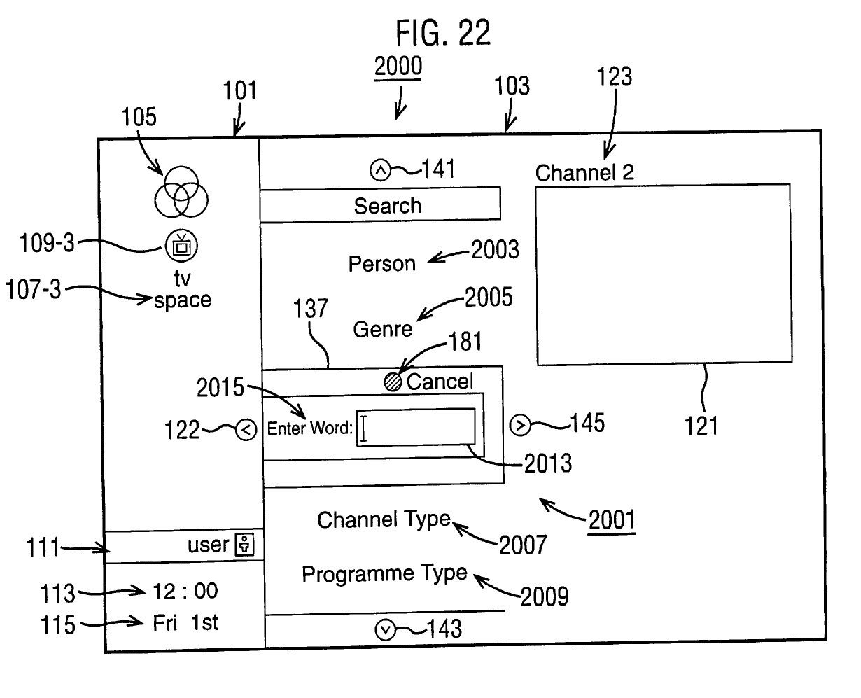

As shown in FIG. 22, once the user has selected one of the search options, the menu screen is changed to present the user with a text input box 2013 and a prompt 2015 to enter the word to be searched. This is shown at operation s91 in FIG. 20. As shown by the cancel icon 181 and the left arrow icon 122 shown in FIG. 22, the user can return to the menu page shown at FIG. 21 either by pressing the left key 907 or the function key 911-3 on the remote control 9. This is illustrated at operation s93 in FIG. 20. Once the user has entered the search word within the text input box 2013 using the keyboard 11, they can proceed with the search by pressing the right arrow key 909 on the remote control 9 (which corresponds to operation s95 in FIG. 20). The search word is then transmitted to the search common function in the user interface server 31, which searches through the appropriate application servers 30 to generate search results which are returned in an appropriate HTML file to the user and displayed in operation s97.

The results page displayed at operation s97 displays the results in a carousel (not shown) similar to those described above. The user can then scroll the search results through a selection window of that carousel and then make a selection by pressing the right arrow key 909 on the remote control 9. This is illustrated at operation s99 in FIG. 20. In this case, the system determines if the requested title is available for playing now in operation s101. If it is, then the television programme or film is streamed to the user in operation s103. If the title is not available now, then at operation s105 the system displays a “title not available” message to the user within the results menu page. As shown in FIG. 20, at this stage, the user can either cancel the request in operation s107 and return to the results menu page displayed at operation s97 or they can add the requested title to their favourites list by pressing, in operation s109, the appropriate favourites function key 911 on the remote control 9. As illustrated at operation s111, the user can also add a selected search result to their favourites list directly from the search results menu page displayed at operation s97. Further, as represented by operation s113, the user can also be changed from the results menu page displayed at operation s97.

Change User

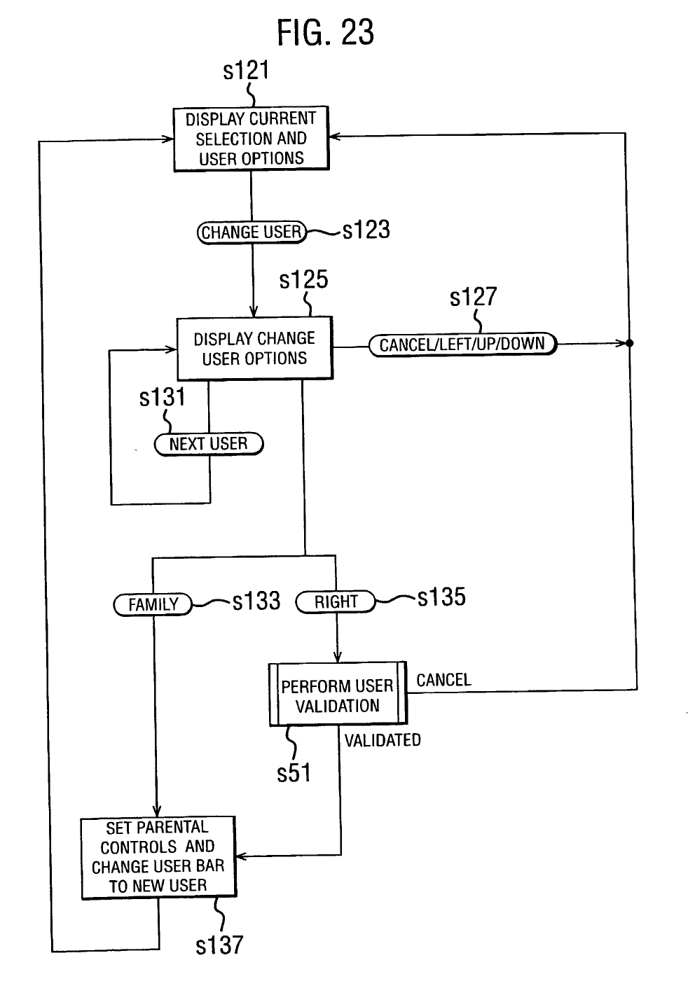

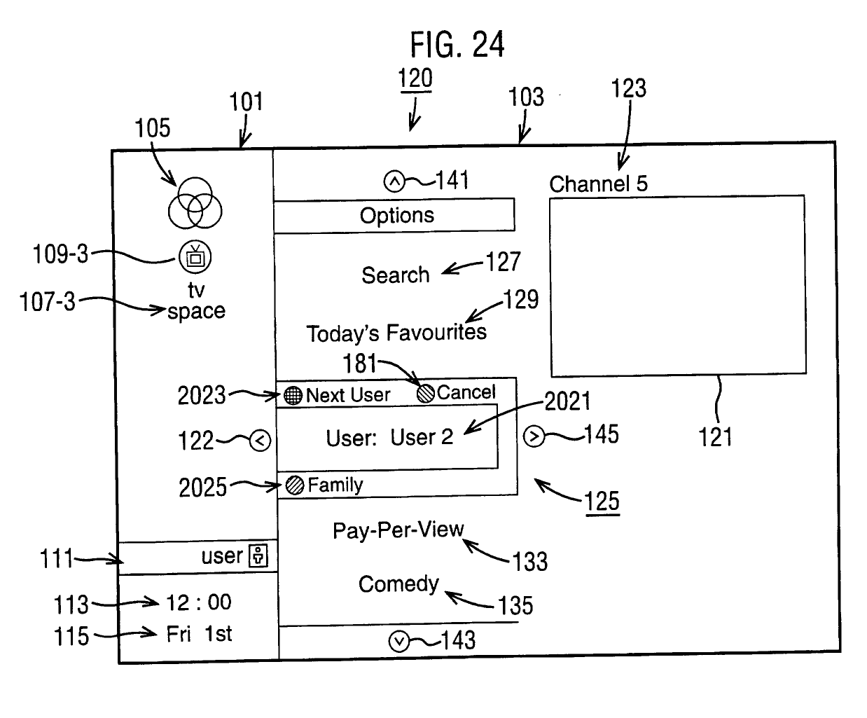

As discussed above, in most of the menu screens, it is possible to change the user that is currently logged on to the system. A more detailed description of this change user procedure will now be described with reference to FIGS. 23 and 24. In this embodiment, the menu system is arranged so that if the user presses the change user button from within a particular menu page, then after the user has been changed the user returns to the menu page from which the change user routine was called. This current menu page is displayed at operation s121 shown in FIG. 23.

When the user presses the change-user function key 911 on the remote control 9 in operation s123, the system modifies the currently displayed menu page to display the change user options in operation s125. This is illustrated in FIG. 24 for the TVspace main menu 120 shown in FIG. 13. As shown, within the selection window 137, the system displays at 2021, the name of another user that may be selected. At this stage, as represented by operation s127, the user can press the function key 911-3, the left key 907, the up key 903 or the down key 905 on the remote control 9, to return to the originally displayed menu page (in this case the menu page shown in FIG. 13). Alternatively, as represented by the next user icon 2023, the user can press the function key 911-1 to scroll through the different users that are associated with the current set top box 7 (e.g. the different family members within the family who use the set top box 7). This is illustrated at operation s131 in FIG. 23.

As represented by the family icon 2025, the user can also set the current user to be the family setting which can be used by all users of the set top box 7. This option is activated by the user pressing the function key 911-2 on the remote control 9 at operation s133. Alternatively, the user can select the current user who is displayed at 2021 within the selection window 137 by pressing, at operation s135, the right key 909 on the remote control 9. In this case, the user validation procedure discussed above at operation s51 is performed. If the user is validated or if the family setting has been entered, the user interface server 31 sets the appropriate parental control settings and changes the login status for the old user and the new user within the database 39. The user interface server 31 also modifies the HTML page for the currently displayed menu page for the new user's preferences, so that when returning to operation s121, the system displays the current menu page in accordance with the new user's preferences and with the new user's name 111 within the left-hand frame 101 of the menu page.

Edit Favourites

As discussed above, it is possible to edit the user's current favourites in order to add a programme or a channel to the user's favourites list. When the user initiates the favourites option, the favourites common function procedure run on the user interface server 31 is initiated. As with the change-user function, in this embodiment, the menu system is arranged so that if the user presses the favourites button from within a particular menu page, then after the user's favourites list has been updated, the user is returned to the menu page from which the favourites routine was called.

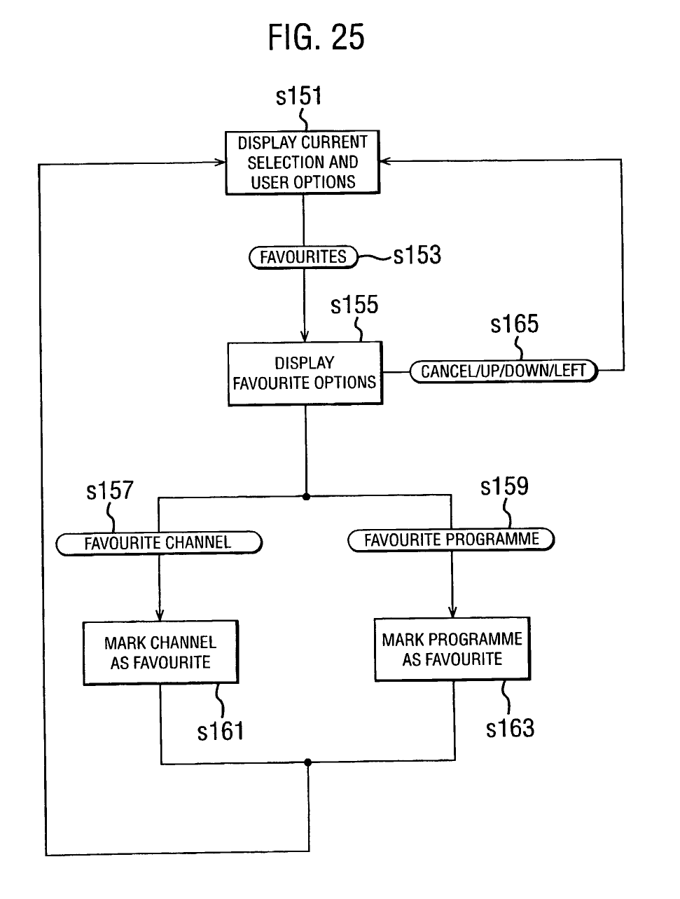

FIG. 25 is a flowchart illustrating an exemplary edit favourites routine. In operation s151, the menu page from which the user activates the favourites option is displayed. When the user presses the favourites function key on the remote control 9 in operation s153, the system displays in operation s155 the favourite options that are available. In this embodiment, the user can add the current channel or the current programme to the user's favourite list. As shown in FIG. 25, these can be activated by pressing a favourite channel key in operation s157 or a favourite programme key at operation s159. The appropriate channel or programme is then added into the user's favourite list at operation s161 and operation s163 respectively. The user is then returned to the menu page from which the favourites option was invoked. Further, as shown in FIG. 25, when the favourite options are displayed in operation s155, the user can return to the previous menu page by pressing, in operation s165, the cancel function key, the up key 903, the down key 905 or the left key 907.

Videospace

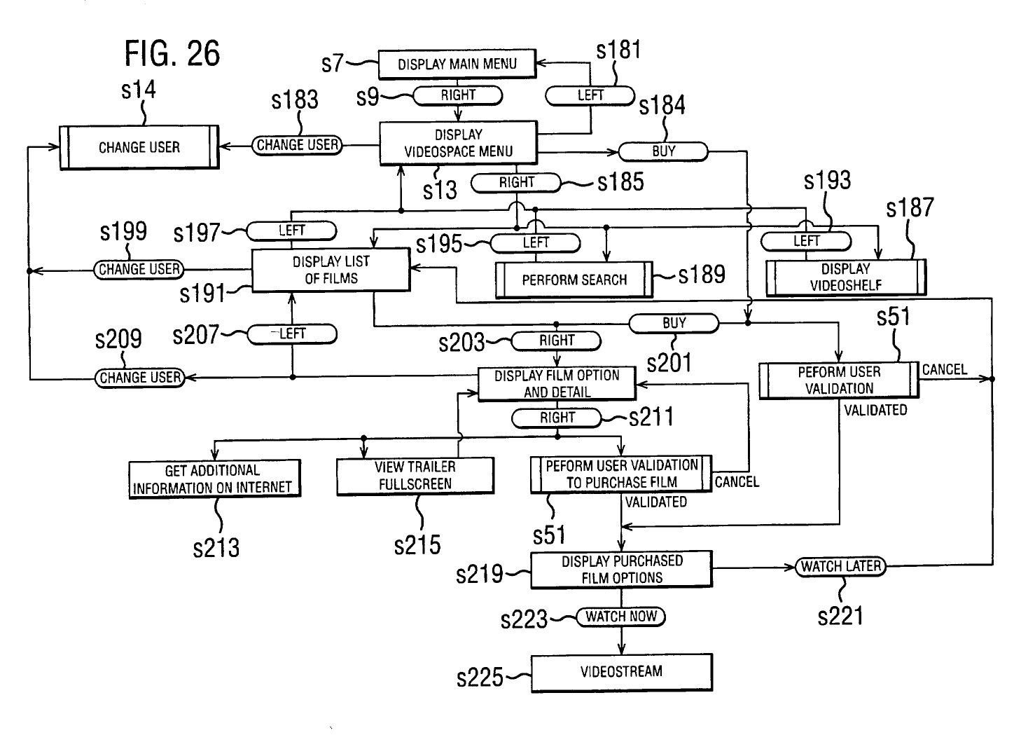

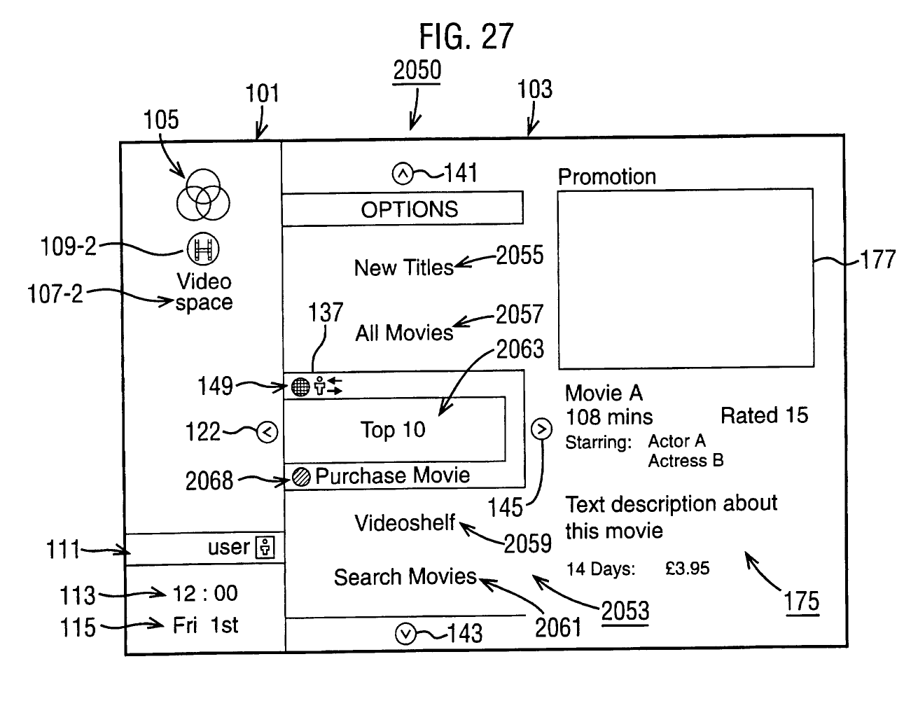

As mentioned above, Videospace 107-2 is the area of the user interface which allows the user to gain access to the video films provided by the video server 15. FIG. 26 is a flowchart illustrating exemplary menu logic associated with Videospace 107-2. The display main menu operation s7 and the display Videospace menu operation s13 are shown again for clarity. The Videospace main menu 2050 used in this embodiment is shown in FIG. 27. As shown, the Videospace main menu 2050 has a similar look and feel to the TVspace main menu 120 and the same elements have been referenced with the same reference numerals and will not be described again. As shown in FIG. 27, the left-hand frame 101 of the Videospace main menu 2050 includes the Videospace logo 109-2 and the Videospace name 107-2, in order to confirm to the user that they are in the Videospace menu.

As shown in the right-hand frame 103, an Options carousel menu 2053 is provided in which the options for identifying a video file to download are presented to the user. As shown, the options include a New Titles option 2055 in which the user can select to browse new video releases; an All Movies option 2057 in which the user can browse through all movies that are available; a “Videoshelf” option 2059 in which the user can browse through videos that the user has previously purchased; and a Search Movies option 2061 in which the user can search for a particular movie either on the video server 15 and/or on the broadcast TV server 27. As shown in FIG. 27, the Videospace options also includes a Top Ten option 2063 which is currently within the selection window 137. This Top Ten option allows the user to browse through the current top ten movies. In this embodiment, the top ten list is personalised for the individual user, for example so that it takes into account the user's age and does not display films that the current user cannot access.

In this embodiment, the Videospace main menu 2050 displays a promotion to the right of the Options carousel 2053. In this embodiment, the promotion includes a graphic which is displayed within a graphics window 177 and beneath that, a text area 175 in which details of the movie being promoted are provided. In the illustration shown in FIG. 27, Movie A is being promoted and the text area 175 identifies the running time, the age rating, the starring actors and actresses and a text description of the movie. The text description also identifies the cost for purchasing the movie and the period of time that the movie can be watched. In this embodiment, the video server 15 uses the user profile information stored within the database 39 in order to personalise the promotion for each user. In particular, the video server 15 uses the user profile information to identify the type of movie that the current user likes to watch and promotes a movie within this category. In this way, the video server 15 can target the promotion directly to the current user.

As represented by the purchase movie icon 2068, the user can elect to purchase the movie being promoted by pressing the function key 911-2 on the remote control 9. This is illustrated in the flowchart shown in FIG. 26 at operation s184. In this case, the user then proceeds to the user validation routine s51 discussed above. Alternatively, the user can return to the main menu by pressing the left key 907 on the remote control 9 in operation s181. Further, as indicated by the change-user icon 149, the logged in user can also be changed from this menu screen by pressing, in operation s183, the function key 911-1 on the remote control 9.

As with carousels on previous menu pages, the user can scroll the Videospace options through the selection window 137 using the up key 903 and the down key 905 on the remote control 9. Once the desired Videospace option is within the selection window 137, the user can press the right key 909 in operation s185 to proceed to the next menu page. If the user selects the Videoshelf option then the system displays the Videoshelf menu page at operation s187. If the user selects the Search Movies option 2061 then the system displays the Search menu page in operation s189. If the user selects any of the other options then the system displays the appropriate list of films menu page at operation s191.

The search option performed in operation s189 is the same as the search option carried out in the TVspace and will not be described again. The display list of films option and the display Videoshelf option will now be described in more detail.

Display List of Films

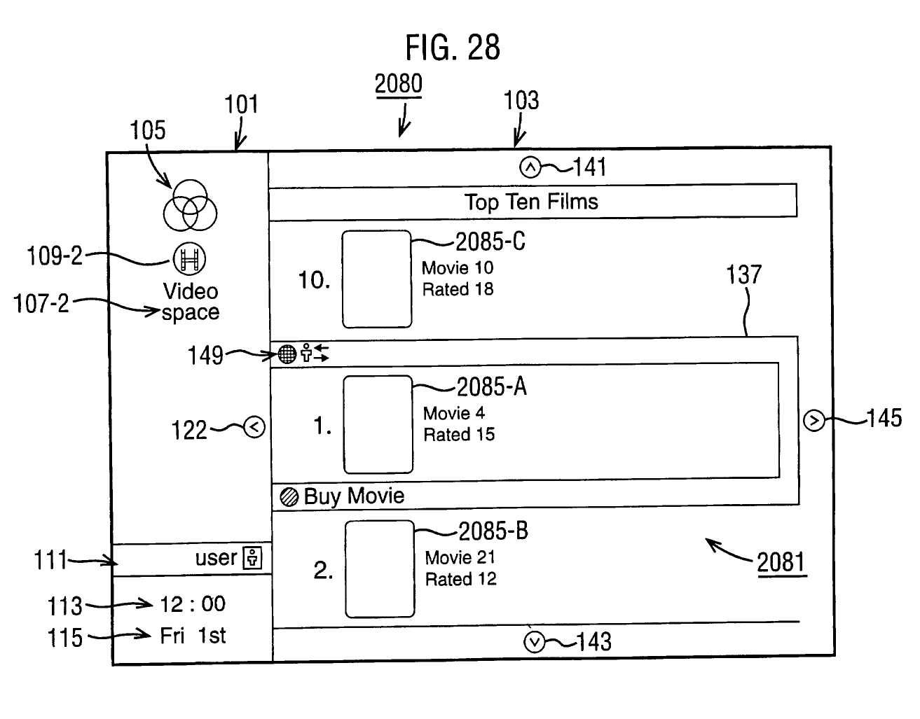

As mentioned above, if the user selects the New Titles option 2055, the All Movies option 2057 or the Top Ten option 2063, then the system retrieves the appropriate list of films from the video server 15 and displays the list in an appropriate menu page in operation s191. FIG. 28 illustrates the Top Ten films menu page 2080 generated if the Top Ten option 2063 is selected. The resulting menu page 2080 that is generated has a similar look and feel to the All Channels menu page shown in FIG. 14, in that it includes the left-hand frame 101 which identifies that the user is currently in Videospace and in the right-hand frame 103 the list of top ten films is provided within a top ten films carousel 2081. As shown in FIG. 28, each movie within the list includes a graphic 2085 associated with the corresponding movie. The name of the movie is also provided together with an age rating for the movie. As with the other carousels, the user can scroll the movies within the top ten list through the selection window 137 by using the up key 903 or the down key 905 on the remote control 9.

As represented by the change-user icon 149, the user can initiate the change-user procedure described above from this menu page by pressing, in operation s199, the function key 911-1 on the remote control 9. The user can also elect to buy the current movie within the selection window 137 by pressing, in operation s201, the function key 911-2 on the remote control 9. As shown, in this case, the user validation routine s51 described above is initiated.

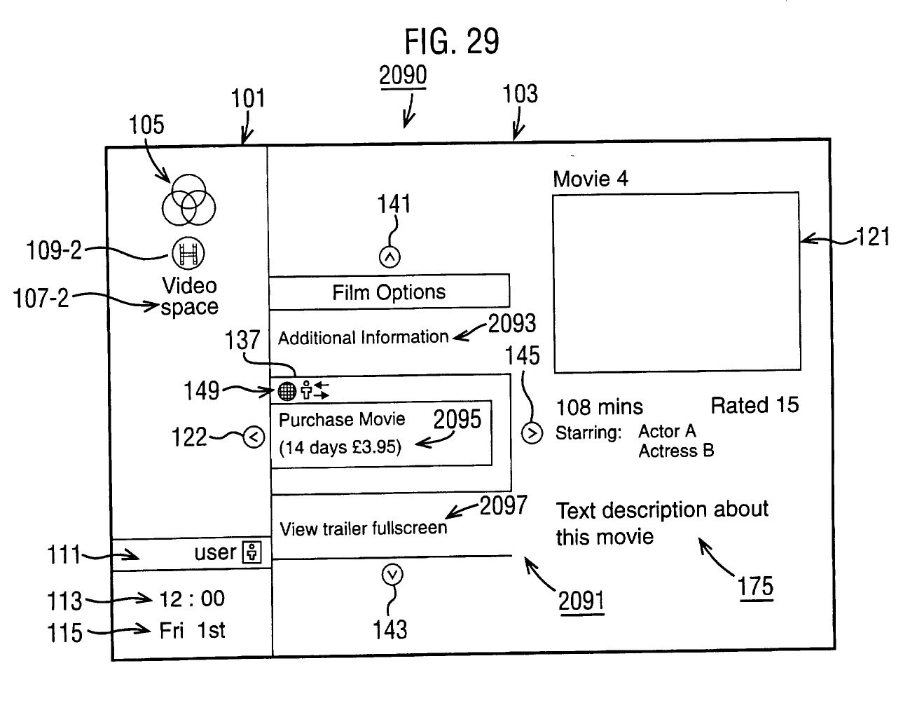

Instead of buying the movie directly from the Top Ten Films menu page 2080, the user can bring up further options for the current film within the selection window 137 by pressing, in operation s203, the right key 909 on the remote control 9. FIG. 29 shows an exemplary resulting menu page 2090 showing the options available for Movie 4. (As shown in FIG. 26, this information is displayed at operation s205.) The menu page 2090 displayed has a Film Options carousel 2091 in which the user can request additional information about Movie 4; purchase the movie; or view a trailer for Movie 4 in full screen. In this embodiment, when the Film Options menu page 2090 is displayed to the user, the trailer for the movie is also played to the user within the video window 121. Additional details about the movie including the running time, the starring actors or actresses and a text description about the movie are provided within a text area 175 under the video window 121. As with the other carousels, the user can press the up key 903 or the down key 905 on the remote control 9 in order to scroll the film options in the carousel 2091 through the selection window 137. The user can also return to the movie list displayed in the Top Ten Films menu page 2080 by pressing, in operation s207, the left key 907 of the remote control 9. As represented by the change-user icon 149, the current user can also be changed by the user pressing, in operation s209, the function key 911-1 on the remote control 9.

As shown in FIG. 26, if the user presses the right key on the remote control 9 in operation s211, then the processing will proceed to operation s213, s215 or s217 depending on which option was within the selection window 137 when the key was pressed. As shown in operation s213, if the Additional Information option 2093 was selected at operation s211, then the system finds additional information from the Internet via the web server 25 and displays the results to the user. If at operation s211, the user selects the View trailer full screen option 2097, then at operation s215 the system plays the trailer in full screen and then, after the trailer has ended, returns the user to the Film Options menu page 2090 shown in FIG. 29.

If the user selects the Purchase Movie option 2095, then the perform user validation routine s51 discussed above is carried out. If the user is not validated, then the user is returned to the Film Options menu page 2090. If the user is validated then at operation s219 the purchased film options are displayed to the user. In this embodiment, these options are watch the purchased film later (s221) or watch the purchased film now (s223). If the user decides to watch the film later then the user is returned to the list of Top Ten Films menu page 2080 shown in FIG. 28 which is displayed at operation s191. Otherwise, if the user decides to watch the film now then the appropriate video stream is streamed down to the user from the video server 15 in operation s225.

Videoshelf

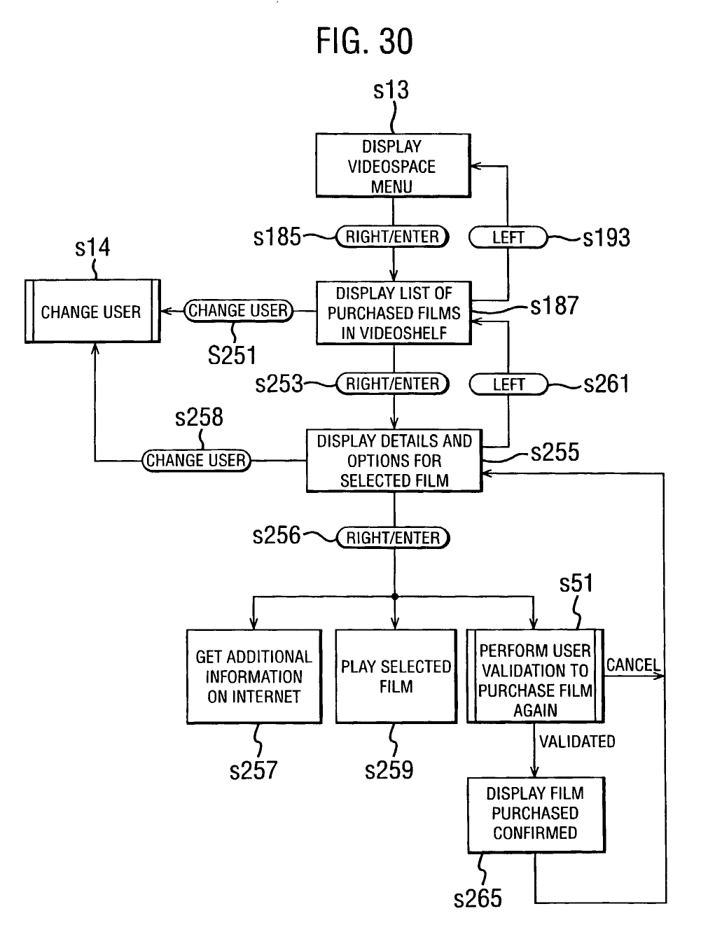

As mentioned above, the Videoshelf option 2059 within the Videospace main menu 2050 allows the user to view the list of films that the user has previously purchased. Exemplary menu logic associated with this Videoshelf feature is shown in FIG. 30. Operations s13, s185, s187 and s193 are illustrated again for clarity. As shown in FIG. 30, in operation s187, the user can initiate the change user routine s14 discussed above, by pressing, in operation s251, the change user function key on the remote control 9. Alternatively, the user can select one of the movies that is listed in the menu page (not shown) by pressing in operation s253 the right key 909 on the remote control 9. If the user selects a film in this way, then at operation s255, the system displays details and options for the selected film. In this embodiment, these options include an Additional Information option; a Play selected film option; and a Purchase again option. If the Additional Information option is selected at operation s256, then at operation s257 the system retrieves additional information for the selected film from the Internet via the web server 25. If the user selects the Play option at operation s256, then at operation s259, the system plays the film by streaming the appropriate video stream from the video server 15 to the user.

In this embodiment, when a user purchases a film, they do so for a limited period of time only. The Purchase movie again option is therefore provided to allow users to re-purchase films they have previously bought. If a user does decide to re-purchase a film at operation s256, then at operation s51, the system performs the user validation routine discussed above. If the user is not validated, then the system returns to operation s255 where the Videoshelf options are displayed to the user again. If, however, the user is validated then the system confirms to the user in operation s265 that the film has been purchased and then the user is returned to the Videoshelf options page at operation s255.

As shown in FIG. 30, the menu page displayed at operation s255 also allows another user to log in by pressing, in operation s258, the change-user function key 911 on the remote control 9. They can also return to the list of purchased films displayed at operation s187 by pressing, in operation s261, the left key 907 on the remote control 9.

Yourspace

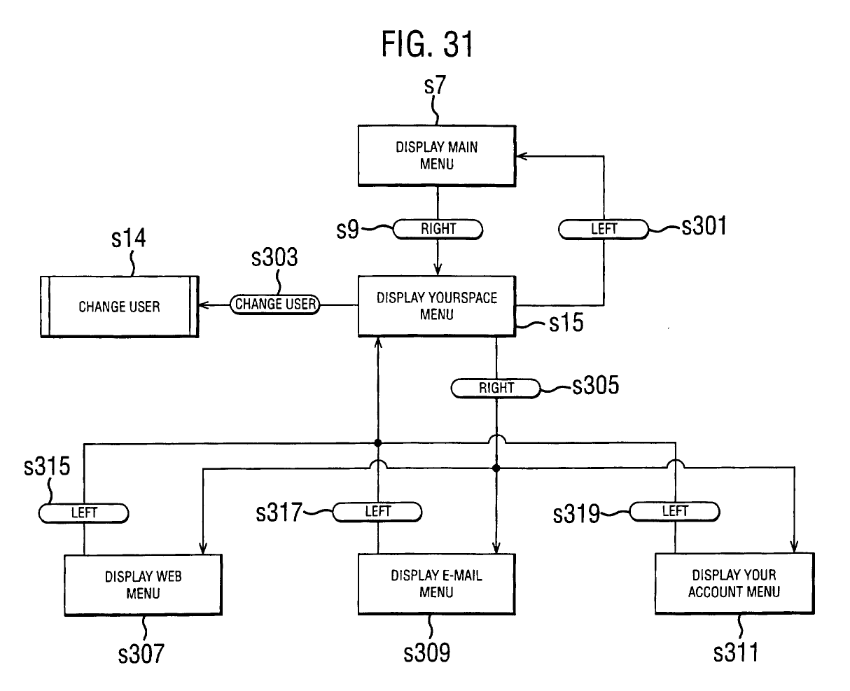

As mentioned above, the Yourspace category 107-1 provides the user with access to the world wide web via the web server 25, E-mail via the mail server 19 and their account information via the management and billing server 29. The menu logic associated with the Yourspace menu category 107-1 is shown in FIG. 31. The display main menu operation s7, the select operation s9 and the display Yourspace menu operation s15 are shown again in FIG. 31 for clarity.

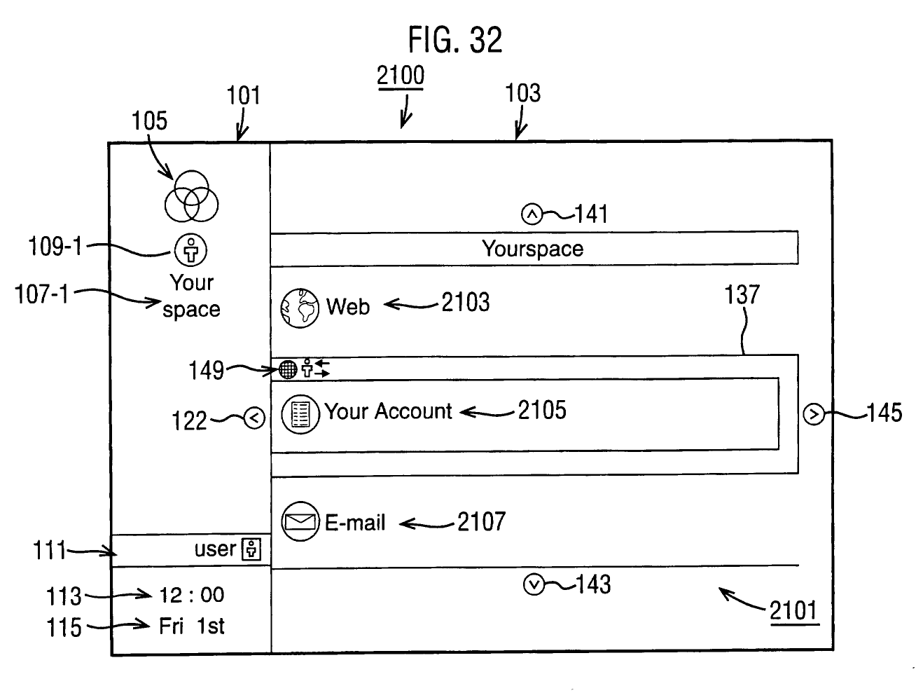

FIG. 32 illustrates a typical Yourspace main menu page 2100 displayed at operation s15. As shown, the Yourspace main menu 32 includes the left-hand frame 101 in which the same elements have been referenced with the same reference numerals and will not be described again. As shown in FIG. 32, the Yourspace logo 109-1 and the Yourspace category name 107-1 are displayed within the left-hand frame 101, to confirm to the user that they are currently within the Yourspace menu category. The left arrow icon 122 is also provided within the left-hand frame 101, confirming to the user that they can press the left key 907 on the remote control 9 to return to the main menu displayed at operation s7. This is illustrated in FIG. 31 at operation s301. Additionally, as represented by the change-user icon 149, the change-user routine s14 can be initiated by the user pressing, in operation s303, the change-user function key 911-1.

As shown in FIG. 32, the right-hand frame 103 of the Yourspace main menu page 2100 includes a “Yourspace” carousel 2101 which lists the options available within the Yourspace menu category 107-1. As shown, in this embodiment, the options include a Web option 2103; a Your Account option 2105; and an E-mail option 2107. As with the other carousels, the user can scroll these options through the selection window 137 and the user can select the desired option by pressing, in operation s305, the right key 909 on the remote control 9. If the user selects the Web option 2103 then the system displays a Web menu in operation s307. If the user selects the E-mail option 2107 then the system displays an E-mail menu in operation s309. If the user selects the Your Account option 2105 then the system displays a Your Account menu in operation s311. As shown in FIG. 31, the user can return to the Yourspace main menu page 2100 from these options pages by pressing the left key 907 on the remote control 9 at operations s315, s317 and s319.

In this embodiment, the options available in the Web menu and the E-mail menu are similar to those available in commercial web browsers and E-mail systems and these will not be described further. A description of the Your Account menu option 2105 is, however, given below.

Your Account

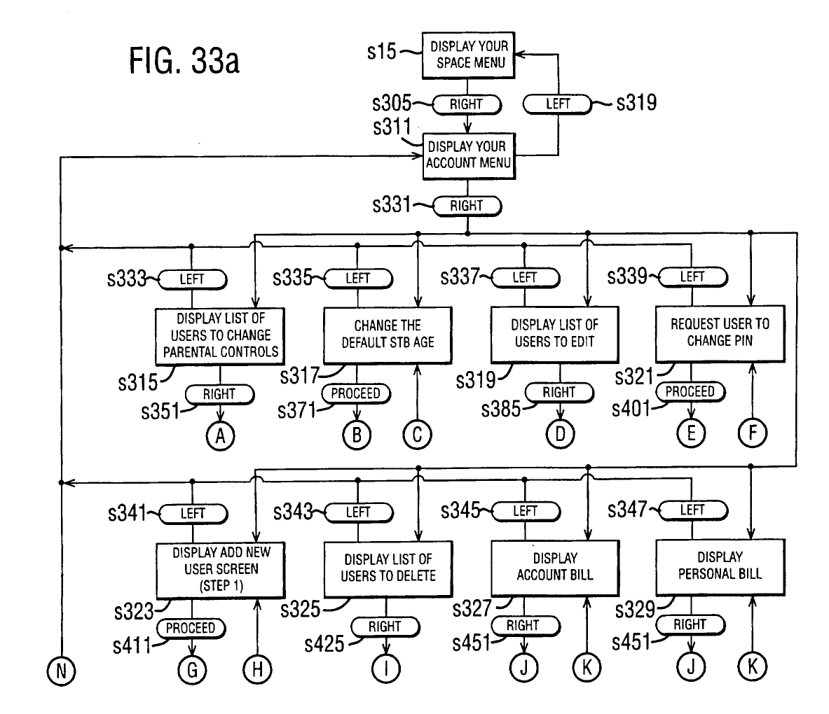

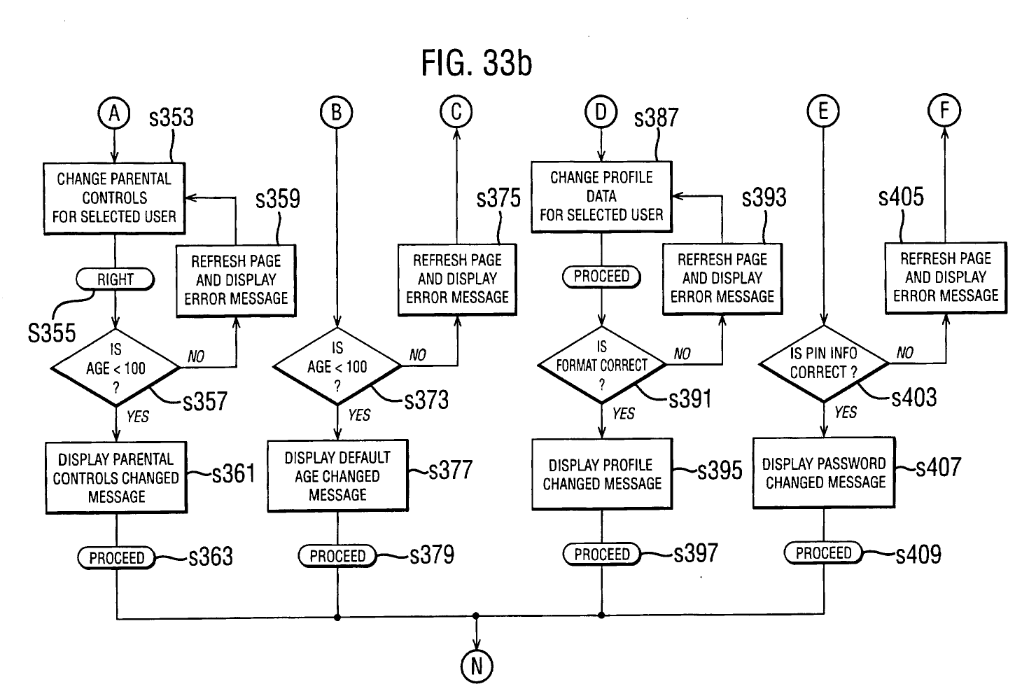

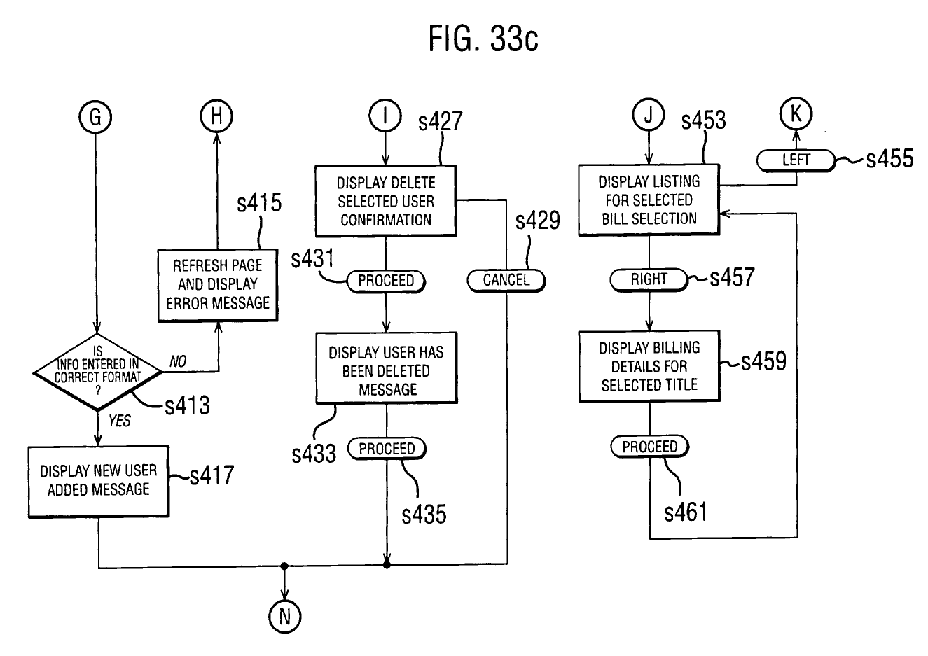

The Your Account option 2105 presented in the Yourspace menu page 2100 allows the user to view and change various user settings and billing information and the like. The menu logic associated with this Your Account option 2105 is shown in FIG. 33. As shown at the top of FIG. 33a, the display Yourspace menu operation s15, the selection operation s305, the display Your Account menu operation s311 and the return operation s319 are shown again for clarity. In the display Your Account menu, the user is given the following options:

i) a parental controls option;

ii) a default set top box age option;

iii) a change profile option;

iv) a change PIN option;

v) an add user option;

vi) a delete user option;

vii) a view account bill option; and

viii) a view personal bill option.

As with other menu pages, these options are displayed to the user in an appropriate carousel (not shown) in which the user can scroll the options through a selection window (not shown) using the up key 903 and the down key 905 on the remote control 9. Once the appropriate option is within the selection window, the user selects the option by pressing the right key 907 on the remote control 9 in operation s331. Once in the appropriate option menu page, the user can return to the Your Account menu page displayed at operation s311 by pressing the left key 907 on the remote control 9 in operation s333, s335, s337, s339, s341, s343, s345 or s347. Each of the eight options given above will now be described in more detail.

Parental Controls

In operation s315, the system displays in an appropriate carousel (not shown) the list of users that are currently associated with the user set top box 7. The user can then press the up key 903 or the down key 905 on the remote control 9 until the desired user is within the selection window (not shown) of the carousel. By pressing, in operation s351, the right key 909 on the remote control 9, the system displays in operation s353 a prompt for the new age limit for the selected user. After the user enters the new age, the user presses, in operation s355, the right key 909 on the remote control 9. The new user information is then transmitted to the user interface server 30 which checks, in operation s357, that the entered age is less than 100. If it is not, then in operation s359, the menu page is refreshed and an appropriate error message is displayed within the selection window of the menu page. If the input age is less than 100, then the user interface server 31 changes the user profile data stored within the database 39 and returns a confirmation page which is displayed to the user, in operation s361, confirming that the parental controls for that user have been changed. In order to return to the Your Account menu displayed at operation s311, the user must press, in operation s363, a proceed function key on the remote control 9.

Default STB Age

If the user proceeds with changing the default set top box age (used when the logged-in user is “family”) at operation s371, then the user interface server 31 checks, in operation s373, if the input set top box age is less than 100. If it is not, then at operation s375, the user interface server refreshes the change default set top box age menu page displayed at operation s317 with an appropriate error message. If, the set top box age is less than 100, then at operation s377 the user interface server transmits a menu page back to the user set top box confirming that the default set top box age has been changed. In order to return to the Your Account menu page displayed at operation s311, the user must press, in operation s379, the proceed function key on the remote control 9.

Edit Profile

If the user selects the edit profile option then at operation s319 the list of users associated with the user set top box 7 are displayed to the user in an appropriate carousel (not shown). The user can then use the up key 903 or the down key 905 to select a user whose profile is to be changed. When this user is within the selection window (not shown) of the carousel, they are selected by the user pressing, in operation s385 the right key 909 on the remote control 9. In response, the user interface server downloads and displays, in operation s387 a page identifying what the current user profile settings are. In this embodiment, these include the user's name, the user's background colour, the user's web home page and web search page etc. The user can then edit these on-screen and then transmit the edited profile back to the user interface server 31 by pressing, in operation s389, a proceed function key on the remote control 9.

Before transmitting the edited profile to the user interface server 31, the web browser 203 checks, at operation s391, if the entries within the amended user profile meet the required format for those entries. If they do not, then at operation s393, the web browser 203 refreshes the change profile menu page displayed at operation s387 with an appropriate error message.

If the format is correct, then the edited profile is transmitted to the user interface server 31 which then transmits a menu page confirming that the user profile for the selected user has been changed. This menu page is displayed at operation s395. The user can then return to the Your Account menu page displayed at operation s311 by pressing, in operation s397, the proceed function key on the remote control 9.

Change PIN

If the user selects the change PIN option, then at operation s321, the user interface server 31 transmits a menu page requesting the user to confirm the current PIN and to input the new PIN. Once the user has input these PIN numbers and presses, in operation s401, the proceed function key on the remote control 9, the PIN information is transmitted to the user interface server 31. At operation s403, the user interface server 31 checks that the current PIN number that the user has entered is correct. If it is not, then at operation s405 an appropriate error message is downloaded and displayed to the user within the change PIN menu screen displayed at s321. If the user interface server 31 determines that the input PIN number is correct, then the user interface server 31 downloads a menu page confirming that the user PIN has been changed, which is displayed at operation s407. The user can then return to the Your Account main menu displayed at operation s311 by pressing, in operation s409 the proceed function key 911 on the remote control 9.

Add User

If the user selects the add new user option, then at operation s323 a new user input screen is displayed to the user. This menu screen prompts the user to provide user information, such as user name, user age, user PIN, user E-mail address etc. Once the user has entered the appropriate information, it is transmitted to the user interface server 31 when the user presses, in operation s411, the proceed function key on the remote control 9. Before transmitting the new user details, however, the web browser 203 checks, in operation s413, that the information that has been entered is in the correct format. If it is not, then at operation s415 the web browser 203 refreshes the menu page displayed at operation s323 together with an appropriate error message. If the entered information is in the correct format, then the web browser transmits the new user information to the user interface server 31, which downloads a menu page in response (displayed at operation s417) confirming that the new user has been added successfully. The user can then return to the Your Account menu displayed at operation s311 by pressing, in operation s419, the proceed function key on the remote control 9.

Delete User

If the delete user option is selected then, at operation s325, the system displays a list of all the users associated with the set top box 7 within an appropriate carousel. The user can then use the up key 903 or the down key 905 to scroll these users through an appropriate selection window. Once the user to be deleted is within the selection window, a request for that user to be deleted is transmitted to the user interface server 31 when the user presses, in operation s425, the right key 909 on the remote control 9. At operation s427, the user interface server 31 transmits an appropriate message to the user set top box 7, requesting the user to confirm that the selected user is to be deleted. At this stage, the user can press, in operation s429, a cancel function key on the remote control 9, in which case the user will be returned to the Your Account menu page displayed at operation s311. Alternatively, the user can press, in operation s431, a proceed function key on the remote control 9, in which case the user interface server 31 deletes the user from the database 39 and returns a message to the user which is displayed at operation s433 confirming that the selected user has been deleted. The user can then return to the Your Account menu page displayed at operation s311 by pressing, in operation s435, the proceed function key on the remote control 9.

Account Bill

If the user selects the account bill option, then at operation s327, the user interface server 31 downloads a menu page displaying a summary for the total bill for all users associated with the user set top box 7. This summary menu page identifies, for example, the amount spent on pay-per-view, in Videospace, in subscriptions to selected channels, on the world wide web, on the shopping server etc. Again, the individual amounts spent on these elements are listed in a carousel so that the user can select one of the elements to obtain further information. For example, the account bill displayed at operation s327 might identify that the total amount spent on pay-per-view over a predetermined period is £50. The user can then select this pay-per-view bill to get a detailed breakdown identifying what items have been purchased and by which users. As with previous carousels, the user presses the up key 903 or the down key 905 in order to scroll the elements displayed in the menu page through a selection window (not shown). The user can then obtain further information about the element in the bill that is currently within the selection window by pressing, in operation s451, the right key 909 on the remote control 9. The set top box 7 then transmits an appropriate request for further information concerning that part of the bill to the management and billing server 29 via the user interface server 31. The management and billing server 29 then downloads further information for that part of the bill which is displayed in an appropriate menu page in operation s453. As shown at operation s455, the user has the option of pressing the left key 907 on the remote control 9 to return to the previous menu page.

In operation s453, the additional information will identify, for example, the different titles of programmes or content downloaded from the various application servers 30. The user can then scroll through these different items in the manner described above, and select one by pressing, in operation s457, the right key 909 on the remote control 9. In response, the management and billing server 29 downloads details identifying the user that purchased the service or content, the time and date that it was purchased etc. This additional information is displayed to the user at operation s459. The user can then return to the menu page displayed at operation s453 by pressing, in operation s461, the proceed function key 911 on the remote control 9.

Personal Bill

The personal bill option is similar to the account bill option discussed above, except only items that have been purchased by the currently logged-on user are downloaded and displayed. A more detailed description of the personal bill option will not, therefore, be given.

Openspace

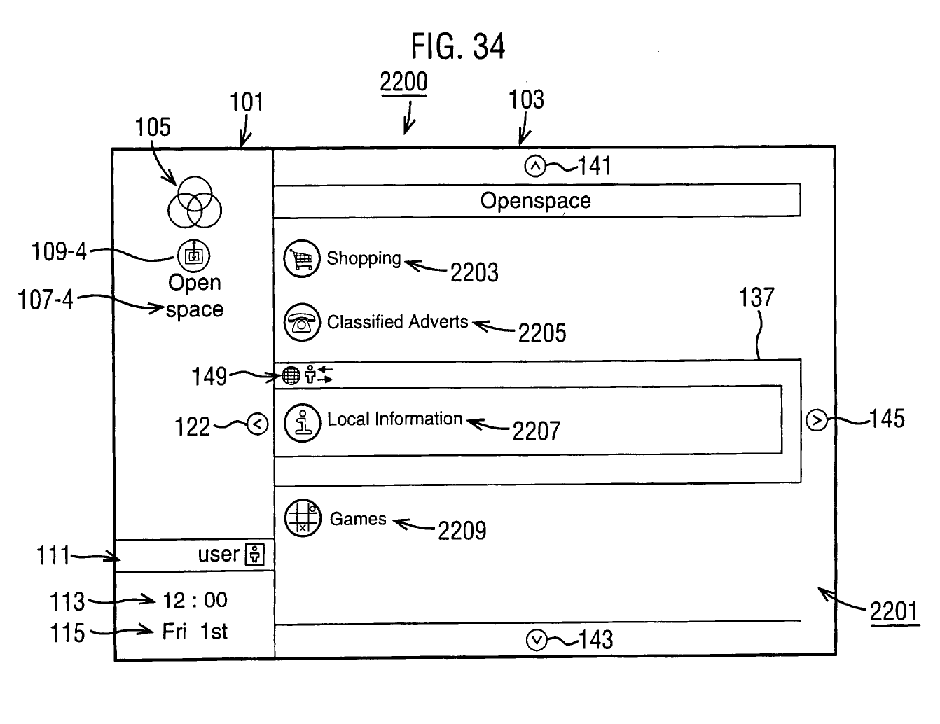

If the user selects the Openspace option from the main menu 120, then the Openspace main menu is displayed at operation s17. The Openspace menu 2200 displayed in this embodiment is shown in FIG. 34. As shown, the Openspace main menu has the same look and feel to the other menu screens shown and described above. The same elements have been referenced with the same reference numerals and will not be described again. As shown in FIG. 34, the left-hand frame 101 includes the Openspace logo 109-4 and underneath that the Openspace category name 107-4. Within the right-hand frame 103, an Openspace carousel 2201 is provided in which the user can select from the following options: a Shopping option 2203; a Classified adverts option 2205; a Local information option 2207; and a Games option 2209. As with previous carousels, the user can scroll these options through the selection window 137 until the appropriate option is within the selection window 137 at which time, the user can press the right key 909 on the remote control 9 to proceed with that option.

In this embodiment, the Shopping option provides the user with access to details of products provided by different vendors. The Classified adverts option 2205 provides the user with access to classified adverts for various products. The Local information option 2207 allows the user to gain access to various types of local information, such as local train times or traffic reports, local news, local weather, local facilities such as schools etc. Finally, the Games option 2209 provides the user with access to various games that are available.

A description has been given above of all of the various menu options that are available to users from the main menu. In addition to these options, the system also includes a short electronic programme guide (SEPG) which the user can access directly when the user is receiving a broadcast television programme. A description of this short electronic programme guide will now be given.

SEPG

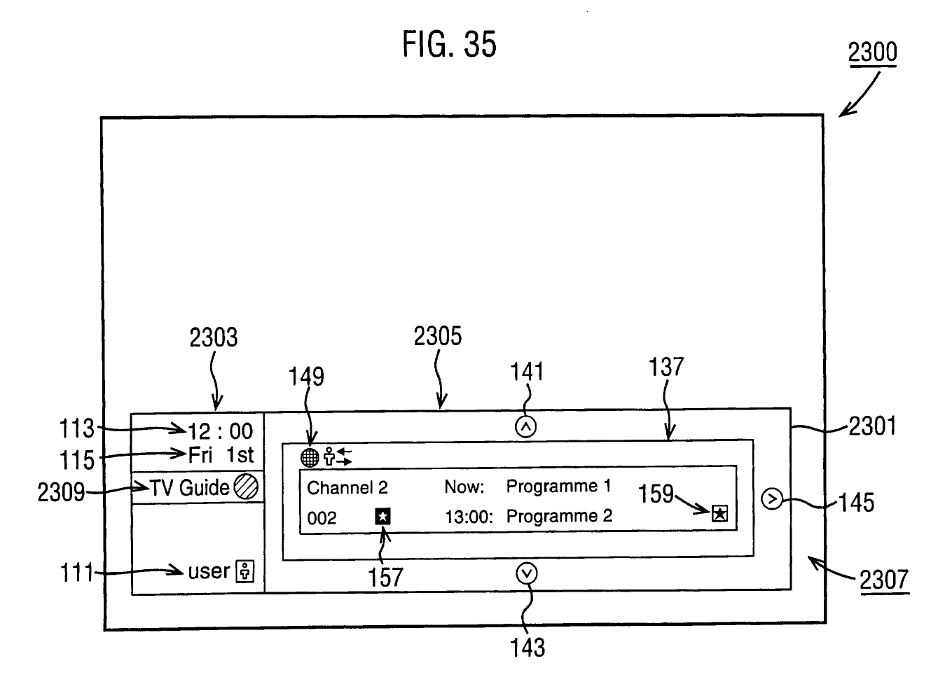

Returning to FIG. 8, in addition to the main menu option that the user can access by pressing the menu key 901 on the remote control 9, the user can also access the short electronic programme guide whilst receiving a broadcast television programme in operation s3. As shown at operation s501, this is achieved by pressing the up key 903 or the down key 905 on the remote control 9. In response, the user set top box 7 downloads a short programme guide for the current channel from the user interface server 31. In this embodiment, this short electronic programme guide is displayed, at operation s503, at the bottom of the television screen overlaid on the current television programme being played. FIG. 35 illustrates the television screen 2300 that is displayed. As shown, a short electronic programme guide frame 2301 is displayed at the bottom of the screen. This SEPG frame 2301 includes the current time 113 and date 115 and the current user name 111 in the left-hand frame 2303. In the right-hand frame 2305 a SEPG carousel 2307 is provided which only includes one entry within the selection window 137. Initially, the channel information will be the channel that is currently being displayed on the television screen 2300. As shown in FIG. 35, this information identifies the channel name, the programme currently playing and the programme playing next, as well as any icons highlighting favourite channels or programmes previously selected by the user.

At this stage, the user has the option to press the up key 903 or the down key 905 to scroll through the different channels that are available. This is illustrated at operation s505 in FIG. 8. As represented by the change user icon 149, the user can press, in operation s507, the function key 911-1 to change the user who is currently logged on to the system, using the change-user routine s14 described above. As represented by the TV guide icon 2309, the user can also access the full electronic programme guide by pressing the function key 911-2 on the remote control 9.

After the user has scrolled through the different channels that are available, they may decide either to return to the channel that they currently watching by pressing, in operation s509, the left key 907 on the remote control 9 (or by making no selection within a predetermined amount of time) or they may decide to change channel to the current channel within the selection window 137 by pressing, in operation s511, the right key 909 on the remote control 9. As shown in FIG. 8, if the user presses the right key 909, then the appropriate request for a change of channel is transmitted to the broadcast television server 27 which changes, in operation s513 the channel being streamed to the user set top box 7.

Summary and Advantages

A television-based system has been described above which allows users to gain access to a plurality of services and content from a plurality of remote servers. One of the advantages of the system described above is that the user gains access to the different servers via a common user interface server. With this structure, the system can employ various intelligent caching techniques to reduce the processing burden on the remote servers and on a common database used by the servers. As a result, it is easier to scale the system to operate with more and more users. Further, by generating the menu pages in the user interface server, it is easier to generate a menu-based user interface which has a common look and feel and through which the user can access the services of all of the different application servers. Further, the menu pages can be personalised for each user not just in terms of format but also the content provided to each user.

The system described above provides a user interface that is personalised for each user. The design, selections, content and layout of the screens of the personalised user interface that are displayed to a user are based on the user's profile data, service operation history and usage information maintained in the system database. The database is accessed by the user interface server as it processes the user's request for the next or the previous menu screen, for access to a system service or application, or for access to specific content. The user interface server creates a personalised menu screen including design elements, services and content based on the profile data and usage information of the user to which the menu will be presented. Each menu screen presented to a specific user has a consistent design, look and feel and includes services and content targeted to the specific user.

Another advantageous feature of the system described above is the use of the carousel having a selection window through which menu items can be scrolled using keys on the remote control. In this way, the system can operate in an intuitive and cursorless manner.

Another advantageous aspect of the system described above is the electronic programme guide. In particular, the guide initially displays what's on now and next associated with each channel in a carousel. Upon appropriate selection, the user can then gain access to the detailed listing for a desired channel, showing the programmes that are on over the next several days. Further, since each menu page can be personalised for each user, the electronic programme guide can be configured to show only the channels that the user has subscribed to. The system may also use user profiling information to list the channels in an order corresponding to how often the user watches the channel. They may also be personalised to identify channels and programmes which have been marked as favourites by the user.

Another advantageous feature of the system described above is the intelligent caching techniques that are employed including the constant swapping techniques which allow generic menu pages to be stored and personalised upon delivery to the individual users. In particular, by using placeholders within the XML documents and style sheets, it is possible to subsequently personalise each menu page by swapping in user specific data for the placeholders. In this way, minor personalisations such as a change in background colour or font, the addition of the user name etc. can be made to the menu page quickly and at the time of delivery. The cached menu pages can therefore be used for a number of different users, thereby saving on cache memory requirements.

A further advantage of the system described above is the use of HTML menu pages and their generation using XML data and style sheets. In particular, since these are standard formats, it is relatively straightforward for third parties to interface their applications to the system.

Modifications and Alternatives

A detailed description has been given above of a television-based system for allowing users to gain access to television services and media content from a number of remote servers using a graphical user interface displayed on the television. As those skilled in the art will appreciate, various alternatives may be made to the system described above. Some of these modifications and alternatives will now be described.

In the above embodiment, the user gained access to the services provided by a plurality of remote servers via a user interface server. This is not essential. For example, the user may gain access to the services or content provided by one or more of the application servers directly, rather than going via the user interface server. The disadvantage of this approach, however, is that if these application servers generate the menu pages and download them directly to the user set top boxes, then it becomes more difficult to maintain a similar look and feel between the menu pages generated by the application servers and the menu pages generated by the user interface server.

In the above embodiment, the user requested services and/or media content from the application servers via the user interface server. In an alternative embodiment, the user may receive menu pages from the user interface server and once a service or media content has been identified for downloading, the user may request that content directly from the appropriate application server. For example, once the user has identified a video to download from the video server, the user device may direct the request for that video directly to the video server, without it being routed through the user interface server. Such an embodiment has the advantage of reducing the number of requests being handled by the user interface server.

In the above embodiment, a common functions processor was provided in each of the user interface servers. This common functions processor was used to perform functions (such as user login, error handling etc.) that are required by two or more of the application servers. As those skilled in the art will appreciate, it is not essential to provide such a common functions processor. It is also possible to implement functions which may only be required by one of the application servers, especially if it is perceived that the common function will be required by application servers which may be added to the system in the future.

In the above embodiment, the user gained access to the television services and media content using a user set top box and a television. As those skilled in the art will appreciate, it is not essential to use such a set top box and television. For example, the user may gain access to the television services and media content using a personal computer (PC) or the like or a hand-held device such as a personal digital assistant (PDA) or mobile telephone.

In the above embodiment, the user interface servers were separate from the application servers. As those skilled in the art will appreciate, one or more of the applications may be run on the same physical machine as the machine running the user interface server. For example, the mail server may be run on the same physical machine as one of the user interface servers. In this case, the user interface server may communicate with the mail server using appropriate memory pointers and call-up routines. Additionally, two or more of the applications may be physically run on a single computer device.

In the above embodiment, the user device is connected to the user interface servers through an IP data network. As those skilled in the art will appreciate, the user device may connect to the user interface server by any appropriate means. For example, the connection may be made via a mobile telephone communication link. Alternatively, the user may connect using a telephone and modem such as an ADSL (asymmetric digital subscriber line) link. Alternatively, the set top box may be connected to the user interface server via a cable or a freespace microwave or optical communication link.

In the above embodiment, the menu screens employed menu carousels having a selection window through which the menu options are scrolled by the user pressing an up or a down key on the remote control. As those skilled in the art will appreciate, it does not matter in which direction the menu options are scrolled through the selection window. For example, the menu options may be displayed horizontally and scrolled through the selection window in a horizontal direction using the left and right keys on the remote control. In such an embodiment, the user could then use the up and down key to navigate between the different menu screens and to select a menu option.

In the above embodiment, the single menu carousel was provided on any menu page. In the detailed menu pages, additional information was provided next to the carousel for the menu item currently within the selection window of the carousel. In an alternative embodiment, two or more carousels may be provided on each menu page, with the user being able to toggle between the carousels using the remote control. For example, a left-hand carousel may be provided for identifying the different channels that are available on the system, with the right-hand carousel identifying the programmes that are on over the next N days on the currently selected channel. The currently active carousel may be identified, for example, by the provision of the up and down arrow icons adjacent thereto.

In the above embodiment, a single database was provided which stored details of all of the users subscribed to the system and which was accessed by the different application servers and user interface servers. As those skilled in the art will appreciate, multiple databases may be provided each storing the same information. This allows database queries from the servers to be shared amongst the different databases. As those skilled in the art will appreciate, such an embodiment would require the databases to be synchronised with each other so that the data stored in each database is the same. Various techniques are known to synchronise multiple databases in this way.

In the above embodiment, the menu pages were generated from HTML web pages downloaded from the user interface server to the user devices. The use of HTML files in this way is preferred since conventional web browser software can be used within the user device to generate the menu page from the received HTML file. Further, menu logic may also be downloaded in the HTML file as Java instructions. This allows the HTML file to contain, for example, details of how the carousel should operate, without having to return to the user interface server each time the user scrolls a menu option through the selection window of the carousel. However, as those skilled in the art will appreciate, it is not essential to download the menu pages in HTML format. The pages may be downloaded as images. In this case, when the user presses a key on the remote control or the keyboard, the user device would transmit the appropriate key press to the user interface server which would then interpret the request and download a new image for display. Whilst such an embodiment is possible, it is not preferred, since it increases the amount of data which has to be transmitted between the user interface server and the user device.

In the above embodiment, the menu pages were generated at the server side of the system and downloaded to the user devices. In an alternative embodiment, the user devices may be arranged to generate the menu pages directly from XML files downloaded from the application servers. In such an embodiment, it is not essential to have the user interface servers, since the user devices can then perform the appropriate personalisation of the menu pages. The disadvantage of such an embodiment is that it adds to the complexity of the user devices. Further, if the common functions originally performed by the user interface server are performed in the user device, then this would also increase the vulnerability of the system to hacking by users.

In the above embodiment, the menu data downloaded from the application servers to the user interface servers were transmitted within an XML document. As those skilled in the art will appreciate, this menu data may be transmitted in any appropriate format from the application servers to the user interface server. For example, this menu data may be transmitted in EJB (Enterprise JavaBeans) format. Since these formats are standard formats, a further description of them will be omitted.

In the above embodiment, both the request handling unit and the response handling unit could call one of the common functions run by the common functions processor. In an alternative embodiment, only the request handling unit may be able to call the common functions. In this case, if an application server wishes to call one of the common functions, then it would have to transmit an appropriate request for the common function via the user set top box. This can easily be done using conventional web redirect techniques.

In the above embodiment, the management and billing server was responsible for monitoring the user requests that were made by all of the users from the data stored within the user request log of the user interface servers. It then used this information to adapt user profiles stored within the database. As those skilled in the art will appreciate, this task may be performed by a separate global operations controller (not shown) or it may be done individually by each of the application servers. For example, each of the application servers may be arranged to monitor the statistics relevant to the services offered by that application server. Each application server can then build a profile of each user that is relevant to that application server.

In the graphical user interface described in the above embodiment, each menu page having different menu options or programme entries were scrolled through a fixed selection window of a carousel. As those skilled in the art will appreciate, the use of such a fixed window or such a carousel is not essential to all of the inventions described in this case. Where a carousel is used, however, the entries in the carousel preferably wrap around so that when the user reaches the last entry in the carousel, the list proceeds again to the first entry in the carousel. However, this is not essential and the options in the carousel may scroll down until the last carousel option is within the selection window. In this case, the option of scrolling in the same direction would not be possible when the user reaches the end of the carousel options.

In the above embodiment, the electronic programme guide provided a detailed channel listing for a selected channel for the next seven days. As those skilled in the art will appreciate, it is possible to have a channel listing for any number of days or even hours. Where programme listings over a relatively large time frame are provided, the system preferably supports a page-up/page-down function to allow users to navigate quickly through the programme listing. In this case, the system would also support hot keys, for example to jump to the top of the carousel.

In the above embodiment, the user interface main menu had four menu options: a TVspace option, a Videspace option, a Yourspace option and an Openspace option. As those skilled in the art will appreciate, other menu options may be provided. For example, a fifth option could be included for providing a voice-over-Internet (VoIP) service, which could be referred to as “Phonespace”. Therefore, the personalised user interface of the user interface can be laid out in any number of logical sections depending on the number of different entertainment and activity types available in the system.

In the above embodiment, various application servers were described providing various television services to the users of the system. As those skilled in the art will appreciate, the various services that are available are described by way of illustration and should not be construed as limiting in any way. For example, in addition to the applications described above, the system may provide a time-shifted TV service in which programmes may be automatically recorded for users so that they can watch programmes after they have been broadcast. Similarly, a personal video recorder service may be provided in which the user can control programmes that are recorded and stored in the application servers. With such a personal video recorder service, the user would be provided with conventional record, pause, play and rewind options, and, if previously recorded, a fast-forward option so that they can control the delivery of the recorded video. Additionally, services such as video mail and video conferencing may also be provided.

In the above embodiment, each menu page was personalised for delivery to the user. This personalisation included personalised data received from the application servers as well as personalisation to include the users's name and to change the background colour of the menu screen in accordance with the user's preferences. In addition to these personalisations, the menu screen may also be personalised in terms of a language used, font used, the format of the date and time displayed etc. The personalisation may also include personalised advertising targeted to the user in accordance with their user profile. For example, by analysing a user's viewing habits and system usage, the system may determine that the user likes action movies. Accordingly, the advertising may be targeted to products relating to such action movies.

In the Tvspace and Videospace options described above, the user could buy pay-per-view programmes or video programmes for viewing. As an additional option, the system may be adapted to provide the option of purchasing the programme or video with or without advertisements. In this way, the user can select to pay a lower price for the programme or video provided they receive the advertisements as well.

In the above embodiment, a menu system has been described via which a user can gain access to various services provided by a number of remote application servers. In one embodiment, the user interface server preferably includes a help menu screen via which the user can access video help for each service and the overall operation of the system.

As those skilled in the art will appreciate, the client devices, the user interface servers and the application servers may be provided as hardware units or as a mixture of hardware and software components. If programmable computer devices are used as the basis for these components, the servers are preferably Microsoft NT servers, Linux Intel servers, Sun Solaris servers, Compac Alpha servers, IBM or HP servers or the like. Where user set top boxes are provided, these are preferably manufactured by Scientific Atlanta, Motorola, AT&T or Philips. If the user device is formed by a personal computer, then this is preferably a Pentium-based computer manufactured by, for example, Dell Computer Corporation, IBM or Toshiba and is connected either to a television or to another display device. The software used to control the servers to carry out the functions described above may be written in various computer languages such as C, C++, Java or Perl. The code may be stored in compiled format, in uncompiled format or in any format intermediate the two. The software may be provided on a carrier such as a CD-ROM or the like or it may be downloaded over a data network such as the Internet.

In the above embodiment, various caches were provided both in the user interface server and in the application servers. These caches were provided in order to try to reduce the processing burden on either the application server or on the database. As those skilled in the art will appreciate, the caching performed in the above embodiment is not essential. One or more of the caches that are used may be omitted. For example, the XML cache within one or more of the user interface servers may be omitted leaving just the HTML cache and the XSLT cache. Additionally, a menu cache may be provided locally within each user device to store menu pages previously downloaded from the user interface server. In this case, the user device can check its local cache before transmitting a request for a next menu page. In this way, the number of requests transmitted to the user interface servers can also be minimised.

In the above embodiment, a variable swapping technique was used to swap in user personalisations into the menu pages that were generated within the user interface server. This technique was also used to swap in machine data for each of the user interface servers. As those skilled in the art will appreciate, this is not essential. The menu pages that are generated may be generated for each specific user and for each user interface server. However, the use of these variable swapping techniques are preferred because it increases the effectiveness of the caching being employed because of the more generic nature of the cached menu pages. Further, if a variable swapping technique is used, it is not essential to use the hash delimiters to identify the placeholder entries. Any suitable character which is not a control character for HTML or the style sheets could be used.

Common Look and Feel Guidelines Embodiment

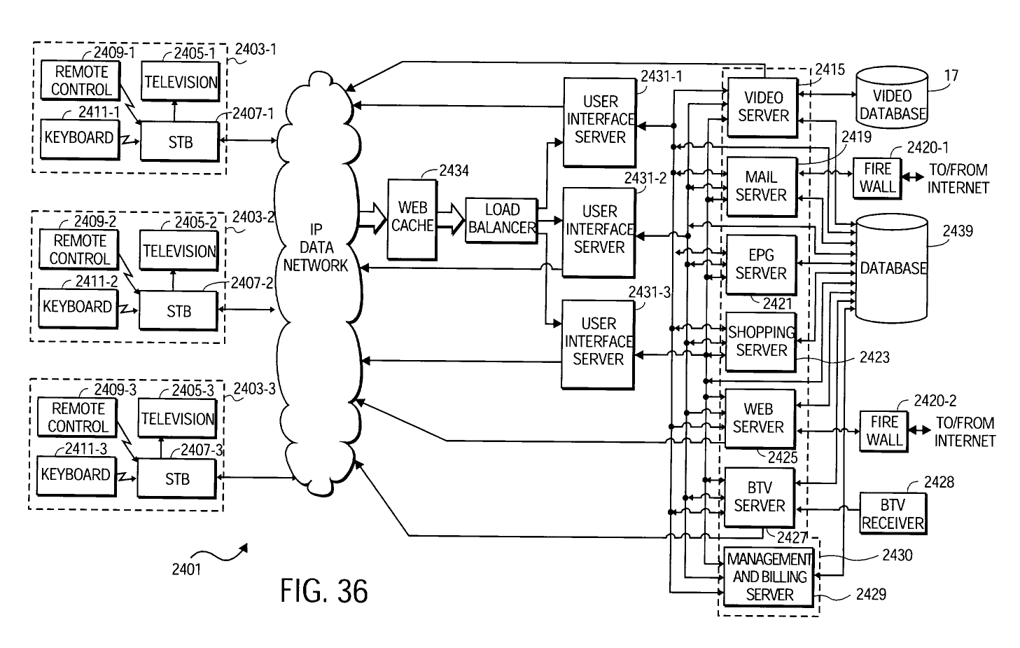

FIG. 36 is a schematic block diagram illustrating example components of an alternate embodiment of system 1 illustrated in FIG. 1. The different users of a system 2401 access the services and content via a respective user device 2403, three of which are shown in FIG. 36 and referenced 2403-1, 2403-2 and 2403-3. As shown in FIG. 36, in this embodiment, each user device 2403 may include a television 2405, a STB 2407, a remote control device 2409 and a keyboard 2411. Menus for accessing the various services and content that are available are displayed to the user on the television 2405 and the user selects and controls the accessing of the services and content using the remote control 2409 and/or the keyboard 2411.

In this embodiment, the services that the user can access include:

i) video on demand (e.g. films on demand, music on demand, time shifted TV, personal video recorder, video commerce etc.) from a video server 2415 and a video database 2417;

ii) e-mail from a mail server 2419 which is connected to the Internet via a firewall 2420-1;

iii) an electronic programme guide (EPG) from an EPG server 2421;

iv) electronic commerce from a shopping server 2423;

v) Internet/world wide web access via a web server 2425 and a fire wall 2420-2;

vi) broadcast TV (BTV) including basic television channels, premium channels, pay-per-view etc. provided by a BTV server 2427 and a BTV receiver 2428; and

vii) user services such as billing information, user profiles etc. provided by a management and billing server 2429.

For ease of reference, as with the embodiment illustrated in FIG. 1, the above servers will hereinafter be collectively referred to as application servers 2430.

As shown in FIG. 36, in this embodiment, the accessing of the services or content provided by the application servers 2430 is carried out via a number of user interface servers 2431, three of which are shown in FIG. 36 and referenced 2431-1, 2431-2 and 2431-3. The user interface servers 2431 are operable to receive user requests transmitted from the associated set top box 2407 via an IP data network 2433, a web cache 2434 and a load balancer 2435 (which shares the user requests between the user interface servers 2431, based on how busy each is). In this embodiment, the user gains access to the different services and content provided by the application servers 2430 via user interfaces (e.g., menu pages rendered from HTML files). In this embodiment, in contrast to the embodiment of FIG. 1, these user interfaces (e.g., HTML files) are assembled by the set top box 2407. A web browser 3203 in the set top box 2407 then generates or renders the appropriate user interfaces which it displays to the user on the television 2405. In the exemplary embodiment shown in FIG. 36, the web cache 2434 is used to deliver static and cacheable dynamic content directly to the set top box 2407. While a web cache 2434 is optional, it has the advantages of reducing page latency, reducing application server and database server resources, and increased scalability.

In one embodiment, the set top box 2407 may accordingly include at least a portion of the functionality and components described above as being incorporated within a user interface server. These components and functionality allow the set top box 2402 to generate user interfaces (e.g., HTML files) based on generic data (e.g., XML files). In this embodiment, the generic data may be obtained from a user interface server 2431 (e.g., where the generic data may have been cached) or directly from an application server 2415. Accordingly, while in one embodiment of the present invention the functionality to generate user interfaces based on generic data may be embodiment within the GUI Assembler 3204 described below, components and functionality (e.g., caching, variable swapping) described above as residing within a user interface server 31 or an application server 30 may be present within the set top box 2407.

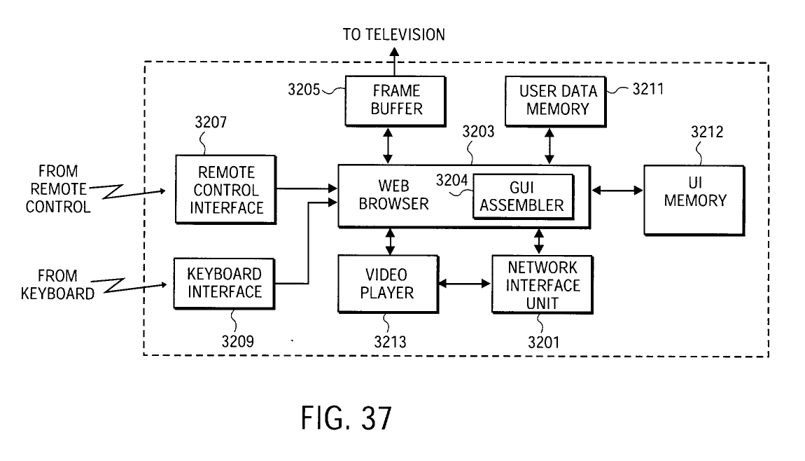

FIG. 37 is a functional block diagram illustrating exemplary main components of one of the set top boxes 2407 shown in FIG. 36. As shown in FIG. 37, the set top box 2407 includes a network interface unit 3201 which operates to interface the set top box 2407 to the IP data network 2433. Data files, generic data (e.g., XML, HTML or other descriptor language data), guideline files (e.g., style sheets), and Java files received from a user interface server 2431 over the IP data network 2433 are passed, through the network interface unit 3201, to a GUI Assembler 3204. Alternatively, the generic data may be received (e.g., as XML files) from one of the application servers 2430 via the interface unit 3201; from a common function being run on a common functions processor of the set top box 2407 (not shown); or a cache (e.g., an XML or HTML cache)(not shown) that forms part of the set top box 2407.

In the exemplary embodiment, the GUI Assembler 3204 may be loaded into the web browser 3203 which processes the generic data (e.g., XML, HTML etc.) to generate a user interface (e.g., a menu page in the exemplary form of an HTML file) which it outputs to a frame buffer 3205 for display on the television 2405. The web browser 3203 is also operable to receive user input either from the remote control 2409 via the remote control interface 3207 or from the keyboard 2411 via the keyboard interface 3209. As described in greater detail above, the user input is used to scroll through options on the currently displayed menu page and/or to select options from this menu page. An HTML file received from the GUI Assembler 3204 may also include links for other menu pages and/or services and content that are available from the current menu page. The HTML file received from the GUI Assembler 3204 may also include instructions for the web browser which associates key presses on the remote control 2409 and/or the keyboard 2411 to these links. When the user presses a key on the remote control 2409 and/or the keyboard 2411, the web browser 3203 then interprets this key press based on the received instructions to identify the link that the user has selected. In the exemplary embodiment, these instructions are Javascript instructions and the web browser 3203 includes an appropriate Javascript command processor (not shown) for interpreting the instructions. The web browser 3203 then generates an appropriate user request for transmission to an application server 2430, through a user interface server 2431, which user request includes the link corresponding to the key press together with user data (such as user ID, session ID etc.) stored in the user data memory 3211. In one embodiment, the user data memory 3211 may store the user information that is described above with reference to FIG. 3 as being stored in the user data cache 310 of a UI server 31.

Upon start up, in the exemplary embodiment, the STB 2407 initiates a bootstrap process to download and install the components necessary for the GUI Assembler 3204 to assemble the graphical user interface for the web browser 3203 to render. During the bootstrap process the system downloads hidden frames, also known as invisible frames or iframes, user information, local information, and possibly GUI Assembly code. The bootstrap process may be initiated after an initialisation and authentication process. User information may include data such as the program packages the user has subscribed to, other services the user has subscribed to or is eligible to purchase, or any other information relating to the user the GUI Assembler 3204 would use to create a personalized graphical user interface for the user. Local information may include regional, national or language specific information used by the GUI Assembler 3204 to create a localized graphical user interface. Hidden frames, or iframes, are used to implement various components of the GUI Assembly code which, in the exemplary embodiment, are implemented using a JavaScript framework. User specific information uploaded during the bootstrap process is stored in the user data memory 3211.

In the exemplary embodiment, the STB 2407 utilizes a set of common look and feel guidelines (e.g., stylesheets) to assemble the graphical user interface. These look and feel guidelines may be part of the iframes, but may also be implemented in parts of the GUI Assembler 3204, GUI Assembly code, or data downloaded to the STB 2407. The look and feel guidelines may be implemented as data, instructions or code, or both. The STB 2407 receives static and cacheable dynamic data from the web cache 2434, as well as dynamic data from the UI server 2431. The look and feel guidelines are stored in the UI memory 3212.

In the exemplary embodiment, the user information and local information are downloaded during the bootstrap process, and possibly during an update process, but otherwise would not ordinarily be passed to the STB 2407 in most downloads from the web cache 2434 or the UI server 2431. The hidden frames or iframes may be loaded into the GUI Assembler 3204 during the bootstrap process.

The embodiment of FIG. 36 provides enhanced flexibility in allowing application developers to specify and customize the user interface for the associated application, while also providing a common set of interfaces that individual applications may use. Application developers may override common interface functionality with application specific code. Application specific code can take advantage of parts of the interface guidelines in constructing a graphical user interface, or may rely solely on application specific code to assemble a graphical user interface.

The embodiment illustrated in FIG. 36 is particularly adapted to allow alternate graphical user interfaces. More particularly, the embodiment of FIG. 36 allows different graphical user interfaces to be used with different applications. Accordingly, the embodiment of FIG. 36 gives greater flexibility to application design by allowing the application developer to define the user interface most suitable for that application. The exemplary embodiment allows the hidden frame or iframe to include and application data frame for data and business logic to be used by a specific application to generate and render and application specific graphical user interface. The data and code of the application data frame are activated by the application to generate and render the application specific graphical user interface.

The embodiment of FIG. 36 has the additional advantage of allowing only the client, (e.g., the STB 2407) to maintain state. As the graphical user interface is assembled by the STB 2407 requests to the web cache or to the UI server can be for information, which the STB 2407 processes with user specific data to create and display a personalized graphical user interface. Accordingly, the UI server 2431 is relieved of both the processing associated with generating the graphical user interface, as well as the task of retrieving user specific data from the database or application server and passing such information along to the STB.

It will be appreciate that any of the user devices, servers, or other devices described above may be regarded as machines within which a set of instructions, for causing the machine to perform any one or more of the methodologies discussed herein, may be executed. In various embodiments a machine may operate as a standalone device or may be connected (e.g., networked) to other machines. In a networked deployment, a machine may operate in the capacity of a server or a client machine in server-client network environment, or as a peer machine in a peer-to-peer (or distributed) network environment. A machine may be a personal computer (PC), a tablet PC, a set-top box (STB), a television, a Personal Video Recorder (PVR), a Personal Digital Assistant (PDA), a cellular telephone, a web appliance, a network router, switch or bridge, any combination of the above devices, or any machine capable of executing a set of instructions (sequential or otherwise) that specify actions to be taken by that machine. Further, while only a single machine may described above as performing certain operations and functions, the term “machine” shall also be taken to include any collection of machines that individually or jointly execute a set (or multiple sets) of instructions to perform any one or more of the methodologies discussed herein.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a user interface method and system have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An interactive television system comprising:
a plurality of user devices each including a web browser, a frame buffer, a UI memory, a user data memory, and a GUI assembler; and
a plurality of servers coupled to the plurality of user devices,
wherein a personalized graphical user interface is generated by the GUI assembler from generic data received from the server and user specific data from the UI memory.

2. The system according to claim 1, wherein the UI memory includes at least one hidden frame, the hidden frame including data and code, and wherein the GUI assembler constructs the graphical user interface according to the data and code of the hidden frame.

3. The system according to claim 1, wherein the user specific data is loaded into UI memory during an initialisation process.

4. A method of rendering a personalized graphical user interface, the method comprising:
receiving generic data relating to an application at a GUI assembler associated with a user device;
retrieving user specific data from a user data memory associated with the user device;
retrieving a guideline from a UI memory associated with a user device, the guideline specifying a look and feel of the graphical user interface; and
assembling a personalized graphical user interface according to the guideline based on the user specific data and the generic data.

5. The method of claim 4, wherein the guideline is specified by an instruction received from an application server, the guideline corresponding to a graphical user interface for the application provided by the application server transmitting the instruction.

6. The method of claim 4, wherein the guideline is to specify a look and feel for a plurality of applications.

7. The method of claim 4, wherein the guideline is loaded into the UI memory during a bootstrap process.

8. A method of generating a personalized graphical user interface in an interactive TV system, comprising:
receiving an input at a user device from a remote control operated by a user, the input specifying a request to display information different from information contained in a first graphical user interface being presented to the user;
sending a request from the user device to a web interface server for generic information relating to at least one application;
receiving the generic information relating to the at least one application at the user device from a web interface server;
retrieving at least one instruction from a UI memory associated with the user device, the at least one instruction corresponding to a display of generic information in a second graphical user interface; and
assembling the second graphical user interface on the user device according to the at least one instruction retrieved from the UI memory and the generic information received from the web interface server.

9. The method of claim 8, further comprising transmitting the second graphical user interface to a display device.

10. The method of claim 8, wherein the application is a broadcast television application.

11. A user device for an interactive television system, the user device comprising:
a local memory to store user specific data; and
an assembler to generate a personalized graphical user interface utilizing generic data received from a server over network and the user specific data retrieved from the local memory.

12. The user device of claim 11, including a display application to receive the personalized graphical user interface from the assembler, and to cause display of the personalized graphical user interface on a display device associated with the user device.

13. The user device of claim 12, wherein the display application is a web browser.

14. The user device of claim 12, wherein the display device is a television.

15. The user device of claim 14, including a frame buffer, the display application to communicate the personalized graphical user interface to the frame buffer for display on the television.

16. The user device of claim 12, wherein the assembler is loaded into the display application.

17. The user device of claim 11, including a network interface to receive the generic data from the server over the network.

18. The user device of claim 11, wherein the assembler is to generate the personalized graphical user interface utilizing a guideline that specifies a look and feel of the personalized graphical user interface.

19. The user device of claim 18, wherein the assembler is to retrieve the guideline from the local memory.

20. The user device of claim 19, wherein the local memory includes a user interface memory to store the guideline and a user data memory to store the user specific data.

21. A user device for an interactive television system, the user device comprising:
storage means for storing user specific data; and
generation means for generating a personalized graphical user interface utilizing generic data received from a server over network and the user specific data retrieved from the storage means.

22. The user device of claim 21, wherein the generation means is for generating the personalized graphical user interface utilizing a guideline that specifies a look and feel of the personalized graphical user interface.

23. The user device of claim 22, wherein the generation means is for retrieving the guideline from the local memory.

24. An interactive television system comprising:
a user device including a memory, and a user interface assembler; and
a server, coupled to the user device via a network, to provide generic data to the user device via the network,
wherein a personalized graphical user interface is generated by the user interface assembler from the generic data received from the server and user specific data from the memory.

25. A machine-readable medium storing a set of instructions that, when executed by a machine, causes the machine to perform a method including:
receiving generic data relating to an application at an assembler associated with a user device;
retrieving user specific data from a memory associated with the user device;
retrieving a guideline from the memory associated with a user device, the guideline specifying a look and feel of q graphical user interface; and
assembling the graphical user interface according to the guideline based on the user specific data and the generic data.

26. A machine-readable medium storing a set of instructions that, when executed by a machine, causes the machine to perform a method including:
receiving an input at a user device from a remote control operated by a user, the input specifying a request to display information different from information contained in a first graphical user interface being presented to the user;
sending a request from the user device to a server for generic information relating to at least one application;
receiving the generic information relating to the at least one application at the user device from the server;
retrieving at least one instruction from a memory associated with the user device, the at least one instruction corresponding to a display of the generic information in a second graphical user interface; and
assembling the second graphical user interface on the user device according to the at least one instruction retrieved from the memory and the generic information received from the server.
